(19) United States
(12) Patent Application Publication
(10) Pub. No.: US 2024/0343846 A1
(43) Pub. Date: Oct. 17, 2024

(54) POLAR GROUP-CONTAINING OLEFIN COPOLYMER, AND PRODUCTION METHOD THEREFOR

(71) Applicants: The University of Tokyo, Tokyo (JP); JAPAN POLYCHEM CORPORATION, Tokyo (JP)

(72) Inventors: Kyoko NOZAKI, Tokyo (JP); Shan TANG, Tokyo (JP); Go YONEZAKI, Tokyo (JP); Takao TAYANO, Mie (JP); Akio TANNA, Mie (JP)

(73) Assignees: The University of Tokyo, Tokyo (JP); JAPAN POLYCHEM CORPORATION, Tokyo (JP)

(21) Appl. No.: 18/683,062

(22) PCT Filed: Aug. 31, 2022
(86) PCT No.: PCT/JP2022/032736

§ 371 Date: Feb. 12, 2024

(30) Foreign Application Priority Data
Aug. 31, 2021 (JP) 2021-140619

(51) Int. Cl. C08F 210/02; C08F 210/06

(52) U.S. Cl. CPC C08F 210/02; C08F 210/06

(57) ABSTRACT

A polar group-containing olefin copolymer comprising a structural unit (A) derived from at least one kind of monomer selected from the group consisting of ethylene and an olefin containing 3 to 20 carbon atoms, and at least one kind of structural unit (B) selected from the group consisting of a structural unit represented by the following general formula (I) and a structural unit selected from the following general formula (II):

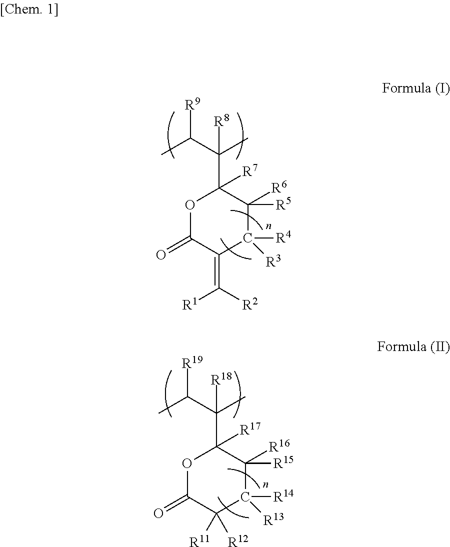

(reference numerals shown in the general formulae (I) and (II) are as described in the DESCRIPTION.)

### TECHNICAL FIELD

The disclosure relates to a novel polar group-containing olefin copolymer and a method for producing the same. In particular, the disclosure relates to a novel polar group-containing olefin copolymer in which a lactone structure is introduced into a side chain, and a method for producing the same.

### BACKGROUND

Among resin materials, an olefin-based polymer such as an ethylene polymer and an ethylene-α-olefin copolymer has excellent properties such as physical properties and moldability, and high economic efficiency and environmental compliance. Accordingly, the olefin-based polymer is a very versatile, important industrial material.

However, due to lack of a polar group, it is difficult to use the olefin-based polymer in applications that require physical properties such as adhesion to other materials, printability, and compatibility with a filler and so on.

In recent years, there is an increase need for a polar group-containing olefin copolymer in which a polar group is introduced into a polyolefin, and various kinds of polymers have been reported.

As the polar group-containing olefin copolymer, a copolymer containing a polar group in a side chain is known. As the copolymer, examples include, but are not limited to, a copolymer containing a carbonyl group in a side chain, which is obtained by copolymerizing ethylene and an acrylic acid ester or a vinyl ketone (for example, see Patent Document 1).

Meanwhile, carbon dioxide is a carbon source that is easily available at low cost, and there is a demand for efficient use thereof. As an example of the use of a polymer material in combination with carbon dioxide, Patent Document 2 discloses a homopolymer obtained by radical polymerization of a lactone monomer produced from carbon dioxide and a 1,3-diene. Patent Document 3 discloses a methacrylic acid ester-based copolymer obtained by radical copolymerization of the lactone monomer and a methacrylic acid ester monomer. The methacrylic acid ester-based copolymer is described to contain a lactone ring in the main chain skeleton. Patent Document 3 is aimed at providing a resin material with its heat resistance improved without impairing the optical transparency or workability of a polymethacrylic acid ester-based resin.

### CITATION LIST

### Patent Documents

Patent Document 1: U.S. Pat. No. 6,309,206
Patent Document 2: Japanese Patent Application Laid-Open (JP-A) No. 2014-240476
Patent Document 3: JP-A No. 2018-168301

### SUMMARY OF INVENTION

### Technical Problem

In Patent Documents 2 and 3, there is no description that the lactone monomer and an olefin monomer, which is a non-polar monomer, are copolymerized.

The present disclosure is to provide a novel polar group-containing olefin copolymer in which a lactone structure is introduced into a side chain of a polymer chain for the purpose of high functionalization of olefin-based polymers.

### Solution to Problem

The present disclosure relates to the following [1] to [6].
[1] A polar group-containing olefin copolymer comprising a structural unit (A) derived from at least one kind of monomer selected from the group consisting of ethylene and an olefin containing 3 to 20 carbon atoms, and
   at least one kind of structural unit (B) selected from the group consisting of a structural unit represented by the following general formula (I) and a structural unit selected from the following general formula (II):

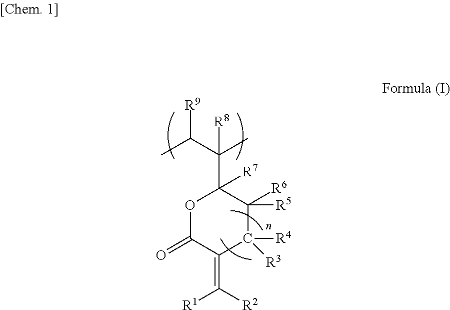

(where R¹, R², R³, R⁴, R⁵ and R⁶ each independently represents a hydrogen atom or a hydrocarbon group containing 1 to 30 carbon atoms and optionally containing a substituent;
   R⁷, R⁸ and R⁹ each independently represents a hydrogen atom or a hydrocarbon group containing 1 to 3 carbon atoms; and
   n is 0, 1 or 2, and when n=0, adjacent carbon atoms are directly bound to each other, and R³ and R⁴ are absent)

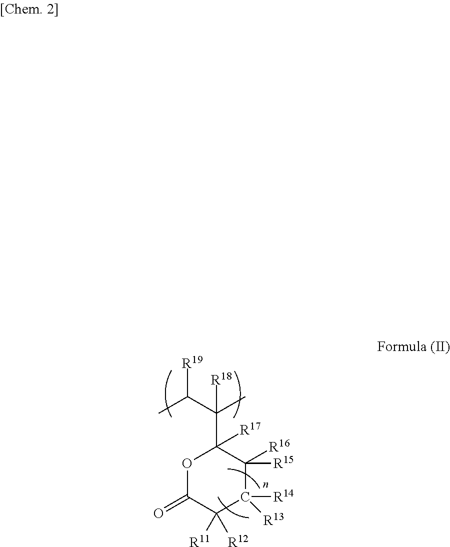

(where R¹¹, R¹², R¹³, R¹⁴, R¹⁵ and R¹⁶ each independently represents a hydrogen atom or a hydrocarbon group containing 1 to 30 carbon atoms and optionally containing a substituent;
   R¹⁷, R¹⁸ and R¹⁹ each independently represents a hydrogen atom or a hydrocarbon group containing 1 to 3 carbon atoms; and
   n is 0, 1 or 2, and when n=0, adjacent carbon atoms are directly bound to each other, and R¹³ and R¹⁴ are absent.)
[2] The polar group-containing olefin copolymer according to [1], wherein a ratio (Mw/Mn) of a weight average molecular weight (Mw) to a number average molecular weight (Mn), both of which are obtained by gel permeation chromatography (GPC), is in a range of from 1.5 to 5.0.
[3] The polar group-containing olefin copolymer according to [1] or [2], wherein the structural unit (A) is derived from ethylene, and a degree of methyl branching calculated by ¹³C-NMR is 20.0 or less per 1,000 carbon atoms.
[4] A method for producing the polar group-containing olefin copolymer defined by any one of [1] to [3], wherein the polar group-containing olefin copolymer is produced in the presence of a transition metal catalyst of the Groups 4 to 10 of the periodic table.
[5] The method for producing the polar group-containing olefin copolymer according to [4], wherein the transition metal catalyst is a transition metal catalyst in which a chelating compound phosphine compound or a chelating carbene is coordinated to nickel or palladium metal.
[6] A method for producing a polar group-containing olefin copolymer,
   wherein the following monomer (A) and the following monomer (B) are polymerized in the presence of a catalyst containing a transition metal of the Groups 4 to 10 of the periodic table:
   monomer (A): at least one kind selected from the group consisting of ethylene and an olefin containing 3 to 20 carbon atoms
   monomer (B): at least one kind selected from the group consisting of a lactone monomer represented by the following general formula (1) and a lactone monomer represented by the following general formula (2):

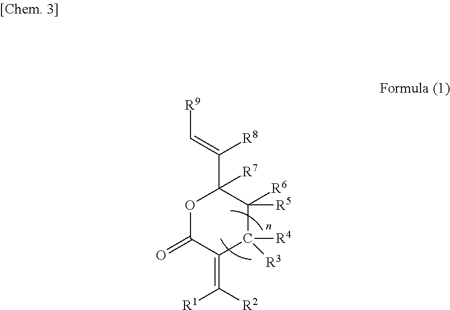

(where R¹, R², R³, R⁴, R⁵ and R⁶ each independently represents a hydrogen atom or a hydrocarbon group containing 1 to 30 carbon atoms and optionally containing a substituent;
   R⁷, R⁸ and R⁹ each independently represents a hydrogen atom or a hydrocarbon group containing 1 to 3 carbon atoms; and
   n is 0, 1 or 2, and when n=0, adjacent carbon atoms are directly bound to each other, and R³ and R⁴ are absent)

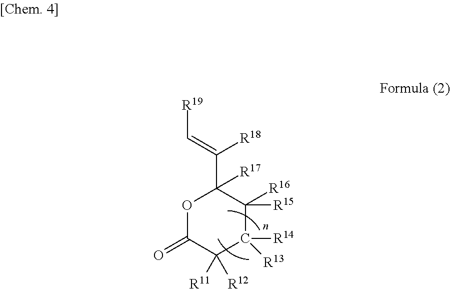

(where R¹¹, R¹², R¹³, R¹⁴, R¹⁵ and R¹⁶ each independently represents a hydrogen atom or a hydrocarbon group containing 1 to 30 carbon atoms and optionally containing a substituent;
   R¹⁷, R¹⁸ and R¹⁹ each independently represents a hydrogen atom or a hydrocarbon group containing 1 to 3 carbon atoms; and
   n is 0, 1 or 2, and when n=0, adjacent carbon atoms are directly bound to each other, and R¹³ and R¹⁴ are absent.)

### Advantageous Effects of Invention

According to the present disclosure, a novel polar group-containing olefin copolymer in which a lactone structure is introduced into a side chain of a polymer chain, is provided.

### BRIEF DESCRIPTION OF DRAWINGS

In the accompanying drawings,

FIG. 1 shows the 1H-NMR measurement results of the polar group-containing olefin copolymer 8 of Example 8;

FIG. 2 shows the 1H-NMR measurement results of the polar group-containing olefin copolymer 11 of Example 11; and

FIG. 3 shows the 13C-NMR measurement results of the polar group-containing olefin copolymer 12 of Example 12.

### DESCRIPTION OF EMBODIMENTS

Hereinafter, the polar group-containing olefin copolymer of the present disclosure will be explained in detail in sections.

In the present DESCRIPTION, the wording “(meth)acryl” denotes “acryl” or “methacryl”.

In the present DESCRIPTION, “to” which shows a numerical range is used to describe a range in which the numerical values described before and after “to” indicate the lower limit value and the upper limit value.

For the prefix of the structural isomer of an alkyl group, “i” means “iso”; “n” means “normal”; “s” means “secondary”; and “t” means “tertiary”. When there is no description of the prefix of the structural isomer of an alkyl group, it means that the alkyl group has a normal structure.

### 1. Polar Group-Containing Olefin Copolymer

The polar group-containing olefin copolymer of the present disclosure is a polar group-containing olefin copolymer comprising

a structural unit (A) derived from at least one kind of monomer selected from the group consisting of ethylene and an olefin containing 3 to 20 carbon atoms, and

at least one kind of structural unit (B) selected from the group consisting of a structural unit represented by the following general formula (I) and a structural unit selected from the following general formula (II):

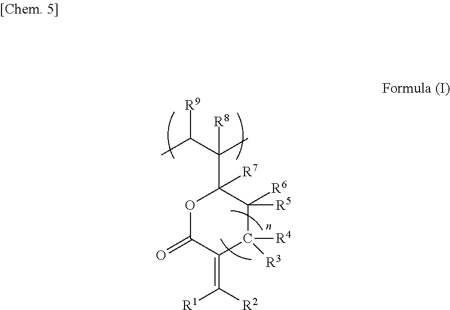

(where R¹, R², R³, R⁴, R⁵ and R⁶ each independently represents a hydrogen atom or a hydrocarbon group containing 1 to 30 carbon atoms and optionally containing a substituent;

R⁷, R⁸ and R⁹ each independently represents a hydrogen atom or a hydrocarbon group containing 1 to 3 carbon atoms; and

n is 0, 1 or 2, and when n=0, adjacent carbon atoms are directly bound to each other, and R³ and R⁴ are absent)

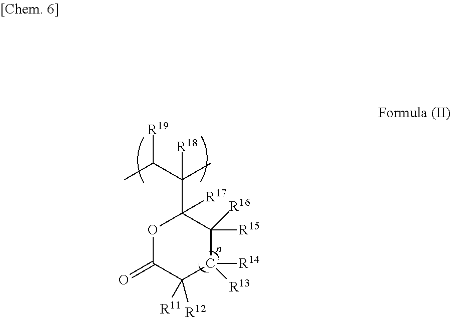

(where R¹¹, R¹², R¹³, R¹⁴, R¹⁵ and R¹⁶ each independently represents a hydrogen atom or a hydrocarbon group containing 1 to 30 carbon atoms and optionally containing a substituent;

R¹⁷, R¹⁸ and R¹⁹ each independently represents a hydrogen atom or a hydrocarbon group containing 1 to 3 carbon atoms; and

n is 0, 1 or 2, and when n=0, adjacent carbon atoms are directly bound to each other, and R¹³ and R¹⁴ are absent.)

The polar group-containing olefin copolymer of the present disclosure is a novel polar group-containing olefin copolymer in which a lactone structure is introduced into a side chain of a polymer chain, and it contributes to high functionalization of olefin-based polymers.

The polar group-containing olefin copolymer of the present disclosure can easily produce a polar group-containing olefin copolymer containing acid or alcohol by, for example, hydrolyzing the lactone structure introduced in the side chain as shown below.

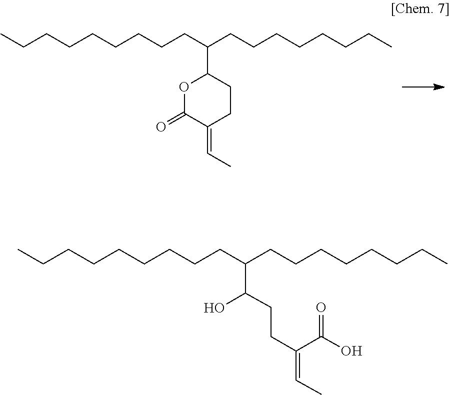

When the polar group-containing olefin copolymer of the present disclosure contains the structural unit represented by the general formula (I), it contains an ethylenically unsaturated group in the side chain and can be post-modified, accordingly. For example, the post-modification may be crosslinking, and the polar group-containing olefin copolymer of the present disclosure also shows promise as a macromonomer.

For example, when the polar group-containing olefin copolymer of the present disclosure contains the structural unit represented by the general formula (I), it contains an enone structure in the side chain. Accordingly, the polar group-containing olefin copolymer of the present disclosure can be used as a substrate for Michael addition reaction, for example.

As described above, the polar group-containing olefin copolymer of the present disclosure is expected to be a raw material that can be turned into various kinds of composite materials.

The polar group-containing olefin copolymer of the present disclosure possesses a new additional value as a carbon recycled resin, since the 6-membered lactone monomer containing the ethylenically unsaturated group that derives the structural unit (B), can be also derived from carbon dioxide.

### (1) Structural Unit (A)

The structural unit (A) is a structural unit derived from at least one kind of monomer (A) selected from the group consisting of ethylene and an olefin containing 3 to 20 carbon atoms.

The monomer (A) used in the present disclosure is at least one kind selected from the group consisting of ethylene and an olefin containing 3 to 20 carbon atoms. The olefin containing 3 to 20 carbon atoms may be a chain or cyclic olefin. As the olefin containing 3 to 20 carbon atoms, examples include, but are not limited to at least one kind selected from the group consisting of an α-olefin containing 3 to 20 carbon atoms and a cyclic olefin containing 4 to 20 carbon atoms.

The α-olefin containing 3 to 20 carbon atoms used in the present disclosure is an α-olefin containing 3 to 20 carbon atoms represented by the following structural formula: CH₂═CHR²⁰ (where R²⁰ is a hydrocarbon group containing 1 to 18 carbon atoms and may be a linear or branched structure). The α-olefin containing 3 to 20 carbon atoms is more preferably an olefin containing 3 to 12 carbon atoms.

As the cyclic olefin containing 4 to 20 carbon atoms, examples include, but are not limited to, cyclobutene, cyclopentene, cyclohexene and norbornene.

As the monomer (A), examples include, but are not limited to, ethylene, propylene, 1-butene, 1-pentene, 1-hexene, 1-octene, 1-decene, 3-methyl-1-butene, 4-methyl-1-pentene and norbornene. From the viewpoint of polymer production efficiency, the monomer (A) is preferably at least one kind selected from the group consisting of ethylene, propylene, 1-butene and norbornene, and it is more preferably ethylene or propylene.

As the structural unit (A), one kind of them may be used solely, or two or more kinds of them may be used in combination.

As the combination of two kinds of them, examples include, but are not limited to, structural units derived from ethylene-propylene, ethylene-1-butene, ethylene-1-hexene, ethylene-1-octene, propylene-1-butene, propylene-1-hexene, propylene-1-octene and ethylene-norbornene.

As the combination of three kinds of them, examples include, but are not limited to, structural units derived from ethylene-propylene-1-butene, ethylene-propylene-1-hexene, ethylene-propylene-1-octene, propylene-1-butene-hexene and propylene-1-butene-1-octene.

In the present disclosure, it is preferable that the monomer (A) used in the structural unit (A) essentially contains at least one kind of ethylene and propylene, and it is more preferable that the monomer (A) essentially contains ethylene or propylene. As needed, the monomer (A) may further contain at least one kind of α-olefin containing 3 to 20 carbon atoms.

With respect to the whole monomer (A) of 100 mol %, the ethylene may be from 65 mol % to 100 mol %, may be from 70 mol % to 100 mol %, or may be from 90 mol % to 100 mol %.

With respect to the whole monomer (A) of 100 mol %, the propylene may be from 65 mol % to 100 mol %, may be from 70 mol % to 100 mol %, or may be from 90 mol % to 100 mol %.

### (2) Structural Unit (B)

The structural unit (B) is at least one kind of structural unit selected from the group consisting of a structural unit represented by the following general formula (I) and a structural unit selected from the following general formula (II):

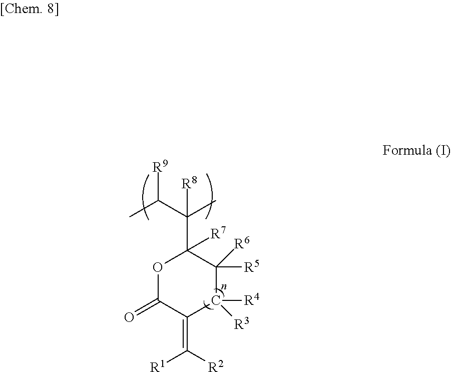

(where R¹, R², R³, R⁴, R⁵ and R⁶ each independently represents a hydrogen atom or a hydrocarbon group containing 1 to 30 carbon atoms and optionally containing a substituent;

R⁷, R⁸ and R⁹ each independently represents a hydrogen atom or a hydrocarbon group containing 1 to 3 carbon atoms; and

n is 0, 1 or 2, and when n=0, adjacent carbon atoms are directly bound to each other, and R³ and R⁴ are absent)

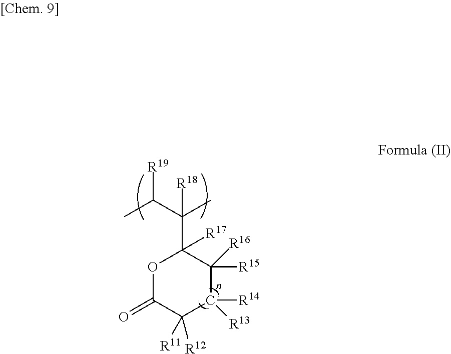

(where R¹¹, R¹², R¹³, R¹⁴, R¹⁵ and R¹⁶ each independently represents a hydrogen atom or a hydrocarbon group containing 1 to 30 carbon atoms and optionally containing a substituent;

R¹⁷, R¹⁸ and R¹⁹ each independently represents a hydrogen atom or a hydrocarbon group containing 1 to 3 carbon atoms; and

n is 0, 1 or 2, and when n=0, adjacent carbon atoms are directly bound to each other, and R¹³ and R¹⁴ are absent.)

In the general formulae (I) and (II), as the hydrocarbon group containing 1 to 30 carbon atoms of the hydrocarbon group containing 1 to 30 carbon atoms and optionally containing a substituent, examples include, but are not limited to, a linear, branched or cyclic, saturated or unsaturated aliphatic hydrocarbon group, an aromatic hydrocarbon group, and a combination thereof. As the hydrocarbon group containing 1 to 30 carbon atoms, examples include, but are not limited to, alkyl groups containing 1 to 30 carbon atoms mentioned below; an alkenyl group such as an ethenyl group, a propenyl group, a butenyl group and a pentenyl group; an aryl group such as a phenyl group, a methylphenyl group, an n-propylphenyl group, an i-propylphenyl group, an n-butylphenyl group, an i-butylphenyl group, an s-butylphenyl group, a t-butylphenyl group, an n-hexylphenyl group, a trimethylphenyl group, a pentamethylphenyl group, a biphenyl group, a naphthyl group, an anthracenyl group, a fluorenyl group and a tolyl group; and an aralkyl group such as a benzyl group, a phenylethyl group, a phenylpropyl, a naphthylmethyl group, a diphenylmethyl group and a triphenylmethyl group.

The alkyl group containing 1 to 30 carbon atoms may be linear, branched or cyclic. As the alkyl group containing 1 to 30 carbon atoms, examples include, but are not limited to, a methyl group, an ethyl group, a 1-propyl group, a 1-butyl group, a 1-pentyl group, a 1-hexyl group, a 1-heptyl group, a 1-octyl group, a 1-nonyl group, a 1-decyl group, a t-butyl group, a tricyclohexylmethyl group, isopropyl an group, a 1-dimethylpropyl group, a 1,1,2-trimethylpropyl group, a 1,1-diethylpropyl group, an isobutyl group, a 1,1-dimethylbutyl group, a 2-pentyl group, a 3-pentyl group, a 2-hexyl group, a 3-hexyl group, a 2-ethylhexyl group, a 2-heptyl group, a 3-heptyl group, a 4-heptyl group, a 2-propylheptyl group, a 2-octyl group, a 3-nonyl group, a cyclopropyl group, a cyclobutyl group, a cyclopentyl group, a methylcyclopentyl group, a cyclohexyl group, a methylcyclohexyl group, a cycloheptyl group, a cyclooctyl group, a cyclododecyl group, a 1-adamantyl group, a 2-adamantyl group and a norbornyl group.

The hydrocarbon group containing 1 to 30 carbon atoms may be a hydrocarbon group containing 1 to 10 carbon atoms; it may be a hydrocarbon group containing 1 to 6 carbon atoms; or it may be a hydrocarbon group containing 1 to 3 carbon atoms.

The hydrocarbon group containing 1 to 3 carbon atoms may be a methyl group, an ethyl group, a 1-propyl group or an isopropyl group; it may be a methyl group or an ethyl group; or it may be a methyl group.

The hydrocarbon group containing 1 to 30 carbon atoms and optionally containing a substituent encompasses a hydrocarbon group containing 1 to 30 carbon atoms and containing a substituent and a hydrocarbon group containing 1 to 30 carbon atoms and not containing a substituent.

As the substituent of the hydrocarbon group, examples include, but are not limited to, a halogen atom, a hydroxy group, a formyl group, an epoxy group, an alkoxy group containing 1 to 30 carbon atoms, an aryloxy group containing 6 to 30 carbon atoms, an amino group optionally substituted with a hydrocarbon group containing 1 to 30 carbon atoms, an acyloxy group containing 1 to 30 carbon atoms, an acyl group containing 1 to 30 carbon atoms, an alkoxycarbonyl group containing 1 to 30 carbon atoms, and an aryloxycarbonyl group containing 6 to 30 carbon atoms. The number of the carbon atoms contained in the substituent is not included in the number of the carbon atoms of the hydrocarbon group.

As the halogen atom, examples include, but are not limited to, a fluorine atom, a chlorine atom, a bromine atom and an iodine atom.

The alkoxy group containing 1 to 30 carbon atoms is a monovalent group represented by —OR^{a} where R^{a} represents an alkyl group containing 1 to 30 carbon atoms or an aralkyl group containing 7 to 30 carbon atoms. For the number of the carbon atoms of the alkoxy group, the lower limit value may be 1 or more, or it may be 2 or more. On the other hand, the upper limit value may be 30 or less; it may be 20 or less; or it may be 10 or less.

As the alkyl group containing 1 to 30 carbon atoms and the aralkyl group containing 7 to 30 carbon atoms in R^{a}, examples include, but are not limited to, those corresponding to the alkyl group containing 1 to 30 carbon atoms and the aralkyl group containing 7 to 30 carbon atoms among the examples of the above-mentioned hydrocarbon group containing 1 to 30 carbon atoms.

As the alkoxy group containing 1 to 30 carbon atoms, preferred examples include, but are not limited to, a methoxy group, an ethoxy group, an n-propoxy group, an i-propoxy group, an n-butoxy group, an i-butoxy group, an s-butoxy group, a t-butoxy group, an n-pentoxy group, an n-hexyloxy group, a cyclopropoxy group, a cyclopentoxy group, a cyclohexyloxy group, an n-octoxy group, an n-decyloxy group and a benzyloxy group.

The aryloxy group containing 6 to 30 carbon atoms is a monovalent group represented by —OR^{a′} where R^{a′} represents an aryl group containing 6 to 30 carbon atoms. For the number of the carbon atoms of the aryl group, the lower limit value may be 6 or more, or it may be 8 or more. On the other hand, the upper limit value may be 30 or less; it may be 20 or less; or it may be 12 or less.

As the aryl group containing 6 to 30 carbon atoms in R^{a′}, examples include, but are not limited to, those corresponding to the aryl group containing 6 to 30 carbon atoms among the examples of the hydrocarbon group containing 1 to 30 carbon atoms.

As the aryloxy group containing 6 to 30 carbon atoms, examples include, but are not limited to, a phenoxy group, a methylphenoxy group, an ethylphenoxy group, an n-butylphenoxy group, a naphthyloxy group, a fluorenyloxy group and an anthracenyloxy group.

The amino group optionally substituted with a hydrocarbon group containing 1 to 30 carbon atoms, is a monovalent group represented by —N(R^{b})R^{c} where R^{b} and R^{c} each independently represents a hydrogen atom or a hydrocarbon group containing 1 to 30 carbon atoms. For the number of the carbon atoms of the hydrocarbon group substituted to the substituted amino group, the lower limit value may be 1 or more, or it may be 2 or more. On the other hand, the upper limit value may be 30 or less; it may be 20 or less; or it may be 10 or less.

As the hydrocarbon group containing 1 to 30 carbon atoms in R^{b} and R^{c}, examples include, but are not limited to, those mentioned above as the hydrocarbon group containing 1 to 30 carbon atoms.

As the amino group optionally substituted with the hydrocarbon group containing 1 to 30 carbon atoms, preferred examples include, but are not limited to, an amino group (—NH₂), a monomethylamino group, a dimethylamino group, a monoethylamino group, a diethylamino group, a monoisopropylamino group, a diisopropylamino group, a monophenylamino group and a diphenylamino group.

The acyloxy group containing 1 to 30 carbon atoms is a monovalent group represented by —OCOR^{d} where R^{d} represents a hydrocarbon group containing 1 to 30 carbon atoms.

The acyl group containing 1 to 30 carbon atoms is a monovalent group represented by —COR^{e} where R^{e} represents a hydrocarbon group containing 1 to 30 carbon atoms.

The alkoxycarbonyl group containing 1 to 30 carbon atoms is a monovalent group represented by —COOR^{f} where R^{f} is an alkyl group containing 1 to 30 carbon atoms or an aralkyl group containing 7 to 30 carbon atoms. The aryloxycarbonyl group containing 6 to 30 carbon atoms is a monovalent group represented by —COOR^{f′} where R^{f′} is an aryl group containing 6 to 30 carbon atoms.

Each of the number of the carbon atoms of the acyloxy group, the number of the carbon atoms of the acyl group, the number of the carbon atoms of the alkoxycarbonyl group, and the number of the carbon atoms of the aryloxycarbonyl group, does not include the number of the carbon atoms of the carbonyl group and refers to the number of the carbon atoms in R^{d}, R^{e}, R^{f} and R^{f′}. The lower limit value of the number of the carbon atoms may be 1 or more, or it may be 2 or more. On the other hand, the upper limit value may be 30 or less; it may be 20 or less; or it may be 10 or less.

As the hydrocarbon group containing 1 to 30 carbon atoms, examples include, but are not limited to, those mentioned above as the hydrocarbon group containing 1 to 30 carbon atoms. R^{f} and R^{f′} may be the same as R^{a} and R^{a′}, respectively.

As the acyloxy group containing 1 to 30 carbon atoms, preferred examples include, but are not limited to, an acetyloxy group, a propionyloxy group, a (meth)acryloyloxy group and a benzoyloxy group.

As the acyl group containing 1 to 30 carbon atoms, preferred examples include, but are not limited to, an acetyl group, a propionyl group, a (meth)acryloyl group and a benzoyl group.

As the alkoxycarbonyl group containing 1 to 30 carbon atoms, preferred examples include, but are not limited to, a methoxycarbonyl group, an ethoxycarbonyl group, an n-propoxycarbonyl group, an isopropoxycarbonyl group, an n-butoxycarbonyl group, a t-butoxycarbonyl group, a cyclohexyloxycarbonyl group, a 2-ethylhexyloxycarbonyl group and a benzyloxycarbonyl group.

As the aryloxycarbonyl group containing 6 to 30 carbon atoms, preferred examples include, but are not limited to, a phenoxycarbonyl group.

In the general formulae (I) and (II), n is 0, 1 or 2.

When n=0, adjacent carbon atoms are directly bound to each other, and R³ and R⁴ are absent in the general formula (I). When n=0, adjacent carbon atoms are directly bound to each other, R¹³ and R¹⁴ are absent in the general formula (II). When n=0, a 5-membered lactone is represented.

When n=1, there is one C(R³)(R⁴) in the general formula (I), and there is one C(R¹³)(R¹⁴) in the general formula (II). Accordingly, a 6-membered lactone is represented.

When n=2, there are two C(R³)(R⁴) in the general formula (I), and there are two C(R¹³)(R¹⁴) in the general formula (II). Accordingly, a 7-membered lactone is represented.

In the general formula (I), R¹, R², R³, R⁴, R⁵ and R⁶ may each independently represent a hydrogen atom or a hydrocarbon group containing 1 to 3 carbon atoms; R¹, R², R³, R⁴, R⁵ and R⁶ may each independently represent a hydrogen atom, a methyl group or an ethyl group; or R¹, R², R³, R⁴, R⁵ and R⁶ may each independently represent a hydrogen atom or a methyl group.

Also in the general formula (I), R³, R⁴, R⁵ and R⁶ may represent a hydrogen atom; moreover, one of R¹ and R² may represent a hydrogen atom, and the other may represent a methyl group.

Also in the general formula (I), R⁷, R⁸ and R⁹ may each independently represent a hydrogen atom, a methyl group or an ethyl group, or R⁷, R⁸ and R⁹ may each independently represent a hydrogen atom or a methyl group.

In the general formula (I), n is 0, 1 or 2, or n may be 1 (n=1).

In the general formula (II), each of R¹¹, R¹², R¹³, R¹⁴, R¹⁵ and R¹⁶ may represent a hydrogen atom or a hydrocarbon group containing 1 to 3 carbon atoms, may represent a hydrogen atom, a methyl group or an ethyl group, or may represent a hydrogen atom or a methyl group.

In the general formula (II), each of R¹³ and R¹⁴ may represent a hydrogen atom; R¹⁵ and R¹⁶ may each independently represent a hydrogen atom or a methyl group; R¹¹ and R¹² may each independently represent a hydrogen atom or a methyl group, and both of them may represent methyl groups.

In the general formula (II), R¹⁷, R¹⁸ and R¹⁹ may each independently represent a hydrogen atom, a methyl group or an ethyl group, or R¹⁷, R¹⁸ and R¹⁹ may each independently represent a hydrogen atom or a methyl group.

In the general formula (II), n is 0, 1 or 2, or n may be 1 (n=1).

As the structural unit (B), examples include, but are not limited to, the following structural units.

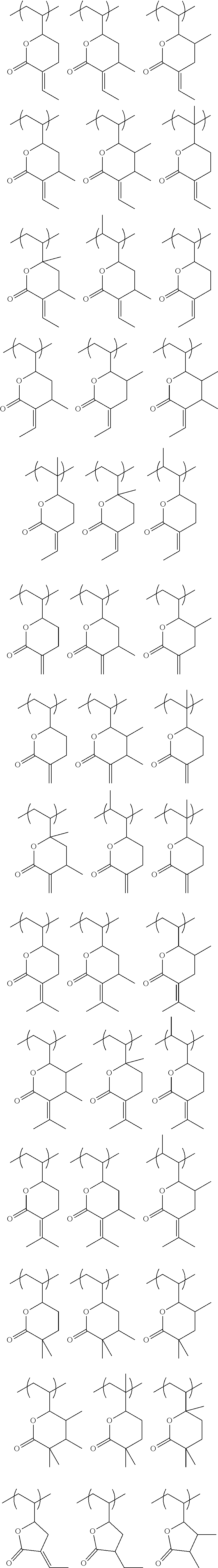

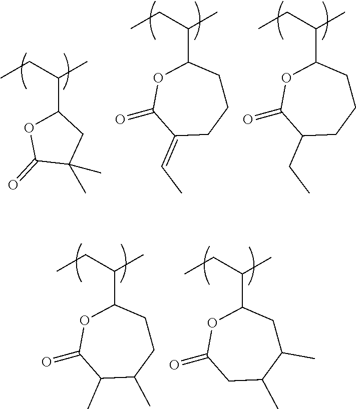

The structural unit (B) may be at least one kind of structural unit selected from the group consisting of the structural units represented by the general formula (I), since it contains an ethylenically unsaturated group in the side chain and can be post-modified, accordingly.

### (3) Another Structural Unit (C)

The polar group-containing olefin copolymer of the present disclosure may further contain another structural unit (C) that is different from the structural units (A) and (B). For example, the structural unit (C) may be a structural unit derived from a monomer that can be polymerized with the monomer (A) in the presence of the below-described transition metal catalyst of the Groups 4 to 10 of the periodic table. As such monomer (C), examples include, but are not limited to, (meth)acrylic acid ester, (meth)acrylamide, (meth)acrylonitrile, vinylamide, vinyl acetate, allyl 3-butenyl acetate, 3-cyanopropene, methyl vinyl ether, 3-chloropropene, N-propylidene ethenamine, 3-(methylthio)-1-propene, 3-(methylsulfinyl)-1-propene, 3-(methylsulfonyl)-1-propene, 2-propene-1-sulfonic acid methyl ester, 2-propenylphosphonic acid dimethyl ester, 5-methoxycarbonyl-2-norbornene, 2-norbornene-5-methanol, 9-epoxy-1-decene, vinylene carbonate, undecenoic acid ester and undecenol.

As the (meth)acrylic acid ester, examples include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-pentyl (meth)acrylate, n-hexyl (meth)acrylate, cyclohexyl (meth)acrylate, n-octyl (meth)acrylate, and 2-ethylhexyl (meth)acrylate.

The polar group-containing olefin copolymer of the present disclosure may contain a lactone monomer-derived structural unit that is different from the structural unit (B), or it may be free of such a structural unit.

### (4) Polar Group-Containing Olefin Copolymer

The polar group-containing olefin copolymer of the present disclosure contains a structural unit (A) derived from at least one kind of monomer selected from the group consisting of ethylene and an olefin containing 3 to 20 carbon atoms, and at least one kind of structural unit (B) selected from the group consisting of a structural unit represented by the general formula (I) and a structural unit selected from the general formula (II).

The polar group-containing olefin copolymer of the present disclosure needs to contain at least one kind of structural unit (A) and at least one kind of structural unit (B) and to contain the structural units derived from a total of two or more kinds of monomers.

In the present disclosure, the content of the structural unit (A) in the polar group-containing olefin copolymer may be appropriately depending selected, on desired physical properties. For example, with respect to the total 100 mol % of the structural units, the lower limit value of the content of the structural unit (A) in the polar group-containing olefin copolymer may be 80.00 mol % or more; it may be 90.00 mol % or more; it may be preferably 95.00 mol % or more; it may be 97.00 mol % or more; or it may be 99.00 mol % or more. On the other hand, the upper limit value may be 99.99 mol % or less; it may be 99.98 mol % or less; it may be preferably 99.90 mol % or less; or it may be 99.80 mol % or less. The upper limit value and the lower limit value may be any combination. Of them, the content of the structural unit (A) in the polar group-containing olefin copolymer may be particularly preferably from 90.00 mol % to 99.98 mol %, may be from 90.00 mol % to 99.90 mol %, or may be from 90.00 mol % to 99.80 mol %, with respect to the total 100 mol % of the structural units.

The content of the structural unit (B) in the polar group-containing olefin copolymer may be appropriately selected, depending on the average molecular weight or desired physical properties. For example, with respect to the total 100 mol % of the structural units, the lower limit value of the content of the structural unit (B) in the polar group-containing olefin copolymer may be 0.01 mol % or more; it may be preferably 0.02 mol % or more; it may be 0.10 mol % or more; or it may be 0.20 mol % or more. On the other hand, the upper limit value may be 20.00 mol % or less; it may be preferably 10.00 mol % or less; it may be 5.00 mol % or less; it may be 3.00 mol % or less; or it may be 1.00 mol % or less. The upper limit value and the lower limit value may be any combination. Of them, the content of the structural unit (B) in the polar group-containing olefin copolymer may be particularly preferably from 0.02 mol % to 10.00 mol %, may be from 0.10 mol % to 10.00 mol %, or may be from 0.20 mol % to 10.00 mol %, with respect to the total 100 mol % of the structural units.

The polar group-containing olefin copolymer of the present disclosure may further contain at least another kind of structural unit (C).

When the polar group-containing olefin copolymer of the present disclosure contains another structural unit (C), with respect to the total 100 mol % of the structural units, the upper limit of the content of another structural unit (C) in the polar group-containing olefin copolymer may be 10 mol % or less, may be preferably 6 mol % or less, or may be more preferably 2 mol % or less. In the polar group-containing olefin copolymer of the present disclosure another structural unit (C) may be 0 mol %. That is, the total content of the structural units (A) and (B) in the polar group-containing olefin copolymer, may be 100 mol % with respect to the total 100 mol % of the structural units.

The structure derived from one molecule of each monomer is defined as one structural unit in the polar group-containing olefin copolymer.

The percentage by mol (mol %) of each structural unit when the whole structural units of the polar group-containing olefin copolymer are defined as 100 mol %, is the structural unit amount.

The polar group-containing olefin copolymer of the present disclosure may be, for example, a random copolymer of the structural unit (A), the structural unit (B) and another structural unit added as needed, a block copolymer thereof, or a graft copolymer thereof. Of these copolymers, the polar group-containing olefin copolymer may be the random copolymer in which the structural unit (B) can be contained in large amounts.

The structural unit amount can be controlled by the following methods.

1) Selection of the catalyst
2) Amount of the monomer added for deriving each structural unit in polymerization
3) Polymerization pressure
4) Polymerization temperature

Effective methods for increasing the structural unit amount of the structural unit (B) in the copolymer, include the following: increasing the amount of the monomer (B) added in polymerization, decreasing the amount of the monomer (A), and increasing the polymerization temperature. For example, it is required to control the structural unit amounts within the desired copolymer range by adjusting these factors.

The structural unit amount of the polar group-containing olefin copolymer of the present disclosure is obtained by use of a ¹H-NMR spectrum and a 13C-NMR spectrum. The NMR spectra can be measured by the method described below under “Examples”.

Especially when the structural unit (A) is derived from ethylene, the degree of methyl branching of the polar group-containing olefin copolymer of the present disclosure, which is calculated by 13C-NMR, may be 20.0 or less per 1,000 carbon atoms. may be 15.0 or less per 1,000 carbon atoms, may be 10.0 or less per 1,000 carbon atoms, may be 8.0 or less per 1,000 carbon atoms, or may be 6.0 or less per 1,000 carbon atoms. When the degree of methyl branching satisfies the range, a high elastic modulus is obtained, and the mechanical strength of a molded body is likely to be high. The degree of methyl branching can be controlled by the polymerization temperature or by the selection of the catalyst used for polymerization. An effective method for decreasing the degree of methyl branching of the olefin copolymer is to decrease the polymerization temperature. For example, it is possible to control the degree of methyl branching within the desired copolymer range by adjusting these factors.

The number of methyl branches is measured as follows. First, the total (Iₜₒₜₐₗ) of the integrated intensities of peaks by carbon atoms at 2 ppm to 60 ppm and 170 ppm to 180 ppm, is normalized to 1,000. Next, the total of the integrated intensity of a signal by the methyl carbon of a methyl branch at 20 ppm, the integrated intensity of a signal by the methine carbon of a methyl branch at 33 ppm, and the integrated intensity of a signal by the methylene carbon of a methyl branch at 37 ppm is obtained, and the total is divided by 4 to obtain a value (I_{B1}). Then, the number of methyl branches per 1,000 carbon atoms is calculated by use of the value I_{B1} and the following formula:

Number of methyl branches (per 1000 carbon atoms)=I_{B1}×1000/Iₜₒₜₐₗ

The chemical shift is set by setting the peak of the methyl carbon of hexamethyldisiloxane to 1.98 ppm. The chemical shift of the peak by another carbon is based on this.

In the present disclosure, the weight average molecular weight (Mw) of the polar group-containing olefin copolymer is generally in a range of from 1,000 to 2,000,000, preferably in a range of from 10,000 to 1,500,000, more preferably in a range of from 20,000 to 1,000,000, still more preferably in a range of from 31,000 to 800,000, and even more preferably in a range of 35,000 to 800,000. When the Mw is 1,000 or more, physical properties such as mechanical strength and impact resistance easily become sufficient. When the Mw is 2,000, 000 or less, difficulty in molding can be easily suppressed.

In the present disclosure, the number average molecular weight (Mn) of the polar group-containing olefin copolymer is generally in a range of from 1,000 to 2,000,000, preferably in a range of from 3,000 to 1,500,000, more preferably in a range of from 4,000 to 1,000,000, still more preferably in a range of from 5,000 to 800,000, and even more preferably in a range of from 5,000 to 600,000. When the Mn is 1,000 or more, physical properties such as mechanical strength and impact resistance easily become sufficient. When the Mn is 2,000, 000 or less, difficulty in molding can be easily suppressed.

In the present disclosure, the ratio (Mw/Mn) of the weight average molecular weight (Mw) to number average molecular weight (Mn) of the polar group-containing olefin copolymer, may be in a range of from 1.5 to 5.0. The Mw/Mn ratio is preferably in a range of from 2.0 to 4.0, and still more preferably in a range of from 2.2 to 3.5. When the Mw/Mn ratio is 1.5 or more, various kinds of processability properties easily become sufficient. When the Mw/Mn ratio is 5.0 or less, good mechanical properties can be easily obtained.

Also in the present disclosure, the Mw/Mn ratio may be referred to as “molecular weight distribution parameter”.

In the present disclosure, the weight average molecular weight (Mw) and the number average molecular weight (Mn) are obtained by gel permeation chromatography (GPC).

In the present disclosure, the GPC measurement can be carried out by the method described below under “Examples”.

### 2. Polar Group-Containing Olefin Copolymer Production Method

The polar group-containing olefin copolymer production method of the present disclosure is a method for producing the polar group-containing olefin copolymer of the present disclosure, wherein the polar group-containing olefin copolymer is produced in the presence of a transition metal catalyst of the Groups 4 to 10 of the periodic table.

In the polar group-containing olefin copolymer of the present disclosure, the following monomer (A) and the following monomer (B) are polymerized in the presence of a catalyst containing a transition metal of the Groups 4 to 10 of the periodic table:

monomer (A): at least one kind selected from the group consisting of ethylene and an olefin containing 3 to 20 carbon atoms

monomer (B): at least one kind selected from the group consisting of a lactone monomer represented by the following general formula (1) and a lactone monomer represented by the following general formula (2):

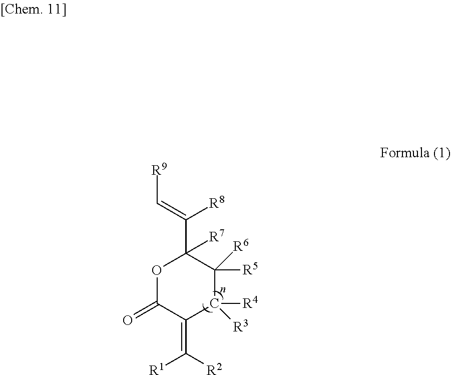

(where R¹, R², R³, R⁴, R⁵ and R⁶ each independently represents a hydrogen atom or a hydrocarbon group containing 1 to 30 carbon atoms and optionally containing a substituent;

R⁷, R⁸ and R⁹ each independently represents a hydrogen atom or a hydrocarbon group containing 1 to 3 carbon atoms; and

n is 0, 1 or 2, and when n=0, adjacent carbon atoms are directly bound to each other, and R³ and R⁴ are absent)

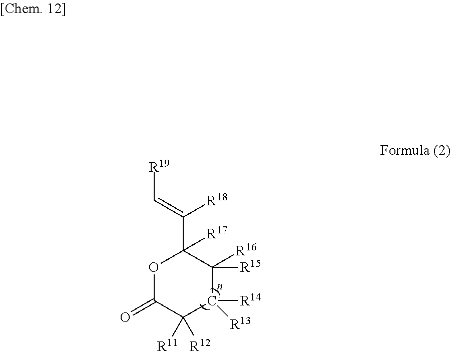

(where R¹¹, R¹², R¹³, R¹⁴, R¹⁵ and R¹⁶ each independently represents a hydrogen atom or a hydrocarbon group containing 1 to 30 carbon atoms and optionally containing a substituent;

R¹⁷, R¹⁸ and R¹⁹ each independently represents a hydrogen atom or a hydrocarbon group containing 1 to 3 carbon atoms; and

n is 0, 1 or 2, and when n=0, adjacent carbon atoms are directly bound to each other, and R¹³ and R¹⁴ are absent.)

### (1) Catalyst

In the production of the polar group-containing olefin copolymer of the present disclosure, polymerization may be carried out in the presence of a catalyst containing a transition metal of the Groups 4 to 10 of the periodic table. In this case, a copolymer containing the structural unit (A) and the structural unit (B) is easily produced.

The catalyst containing a transition metal of the Groups 4 to 10 of the periodic table is not particularly limited, as long as it is a catalyst that can polymerize the following monomers: at least one kind of monomer which is selected from the group consisting of ethylene and an olefin containing 3 to 20 carbon atoms and which derives the structural unit (A), and a lactone monomer which contains an ethylenically unsaturated group and which derives the structural unit (B). For example, the transition metal catalyst may be a transition metal compound of the Groups 5 to 10 of the periodic table, or it may be a transition metal compound of the Groups 5 to 10 of the periodic table, which contains a chelating ligand.

As preferred transition metals, examples include titanium, zirconium, hafnium, vanadium, niobium, tantalum, chromium, molybdenum, tungsten, manganese, iron, platinum, ruthenium, cobalt, rhodium, nickel and palladium. Of them, a transition metal of any of the Groups 8 to 10 of the periodic table is preferred, and a transition metal of the Group 10 is more preferred. As the transition metal of the Group 10, examples include nickel, palladium and platinum. Of them, particularly preferred are nickel (Ni) and palladium (Pd). These transition metals may be used solely or in combination of two or more kinds.

The chelating ligand contains at least two atoms selected from the group consisting of P, N, O, C and S; it contains a bidentate or multidentate ligand; and it is electrically neutral or anionic. Examples of the structure are listed in a review (Chem. Rev., 2000, 100, 1169) by Brookhart, et al.

Preferred examples include a bidentate anionic P, O ligand such as phosphorus sulfonate, phosphorus carboxylate, phosphorus phenoxide, phosphorus alkoxide and phosphorus enolate, a bidentate anionic N,O ligand such as salicylaldiminato and pyridine carboxylate. Other preferred examples include a diimine ligand, a diphenoxide ligand and a diamide ligand.

From the viewpoint of the production efficiency of the polymer, the molecular weight of the polymer, and the copolymerizability of the monomers (A) and (B), the catalyst containing the transition metal is preferably a catalyst containing a late transition metal selected from the group consisting of transition metals of the Groups 8 to 10. Of them, a catalyst containing a transition metal of the Group 10 is preferred. More preferred is a catalyst which contains a transition metal of the Group 10 and which contains a chelating ligand that contains one or more kinds of phosphorus atoms or oxygen atoms as a coordination site with the transition metal of the Group 10.

From the viewpoint of the production efficiency of the polymer, the molecular weight of the polymer, and the copolymerizability of the monomers (A) and (B), the catalyst containing the transition metal may be at least one kind selected from the group consisting of compounds represented by the following general formulae (101), (201) and (202). Also, it may be a transition metal catalyst in which a chelating phosphine compound or a chelating carbene compound is coordinated to nickel or palladium metal.

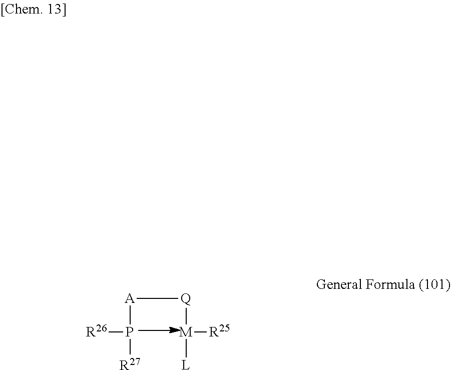

(where M represents a transition metal of the Group 10; Q represents a divalent group shown in the brackets of any one of the following: A[—S(═O)₂—O-]M, A[-C(═O)—O—]M, A[-O-]M, A[-P(═O)(R)—O-]M and A[-S-]M (A and M on both sides are described to show the binding direction of the groups); R represents a hydrocarbon group containing 1 to 30 carbon atoms and optionally containing a functional group; A is a divalent hydrocarbon group containing 1 to 30 carbon atoms, linking Q and a phosphorus atom, and optionally containing a functional group; L represents a zero-valent ligand capable of leaving from metal; R²⁵ represents a hydrogen atom or a hydrocarbon group containing 1 to 30 carbon atoms and optionally containing a functional group; each of R²⁶ and R²⁷ represents a hydrocarbon group containing 1 to 30 carbon atoms and optionally containing a functional group; R²⁵ and L optionally form a ring; R²⁶ and R²⁷ optionally form a ring; and R²⁶ or R²⁷ is optionally bound to A to form a ring.)

In the general formula (101), M represents a transition metal of the Group 10, and it is preferably Ni or Pd.

Q represents a divalent group represented by —S(═O)₂—O—, —C(═O)—O—, —O—, —P(═O)(R)—O— or —S—, and it is a site coordinated to M through one electron. The left side of each formula is bound to A, and the right side is bound to M. From the viewpoint of catalytic activity, Q is particularly preferably —S(═O)₂—O—.

R represents a hydrocarbon group containing 1 to 30 carbon atoms and optionally containing a functional group, and it may be the same as the hydrocarbon group containing 1 to 30 carbon atoms and optionally containing a functional group in R²⁵ described below.

A is a divalent hydrocarbon group containing 1 to 30 carbon atoms, linking Q and the phosphorus atom, and optionally containing a functional group.

The divalent hydrocarbon group containing 1 to 30 carbon atoms is preferably a divalent hydrocarbon group containing 1 to 12 carbon atoms; it is more preferably an alkylene group, an arylene group or the like; and it is particularly preferably an arylene group.

As the functional group of the hydrocarbon group in A, examples include, but are not limited to, a halogen atom, —OR^{α}, —CO₂R^{α}, —CO₂M′, —CON(R^{β})₂, —COR^{α}, —SR^{α}, —SO₂R^{α}, —SOR^{α}, —OSO₂R^{α}, —PO(OR^{α})_{2-y}(R^{β})_{y}, —CN, —NHR^{α}, —N(R^{α})₂, —Si(OR^{β})₃₋ₓ(R^{β})ₓ, —OSi(OR^{β})₃₋ₓ(R^{β})ₓ, —NO₂, —SO₃M′, —PO₃M′₂, —P(O)(OR)₂M′ and an epoxy-containing group (where R^{β} represents a hydrogen atom or a hydrocarbon group containing 1 to 20 carbon atoms; R^{α} represents a hydrocarbon group containing 1 to 20 carbon atoms; M′ represents an alkali metal, an alkaline-earth metal, an ammonium, a quaternary ammonium or a phosphonium; x represents an integer of from 0 to 3; and y represents an integer of from 0 to 2).

As the hydrocarbon group containing 1 to 20 carbon atoms in these examples, examples include, but are not limited to, the same hydrocarbon groups containing 1 to 20 carbon atoms as those among the hydrocarbon groups containing 1 to 30 carbon atoms in the general formulae (I) and (II).

As the divalent hydrocarbon group containing 1 to 30 carbon atoms in A, examples include, but are not limited to, the following formulae (a-1) to (a-7). In the following formulae, R¹⁰¹s are each independently a hydrogen atom, a hydrocarbon group containing 1 to 30 carbon atoms, or a functional group. As the hydrocarbon group containing 1 to 30 carbon atoms in R¹⁰¹, examples include, but are not limited to, the same hydrocarbon groups containing 1 to 30 carbon atoms as those in the general formulae (I) and (II). The hydrocarbon group containing 1 to 30 carbon atoms is preferably a hydrocarbon group containing 1 to 20 carbon atoms, and more preferably a hydrocarbon group containing 1 to 10 carbon atoms.

From the viewpoint of catalytic activity, the divalent hydrocarbon group containing 1 to 30 carbon atoms in A may be the following formula (a-7).

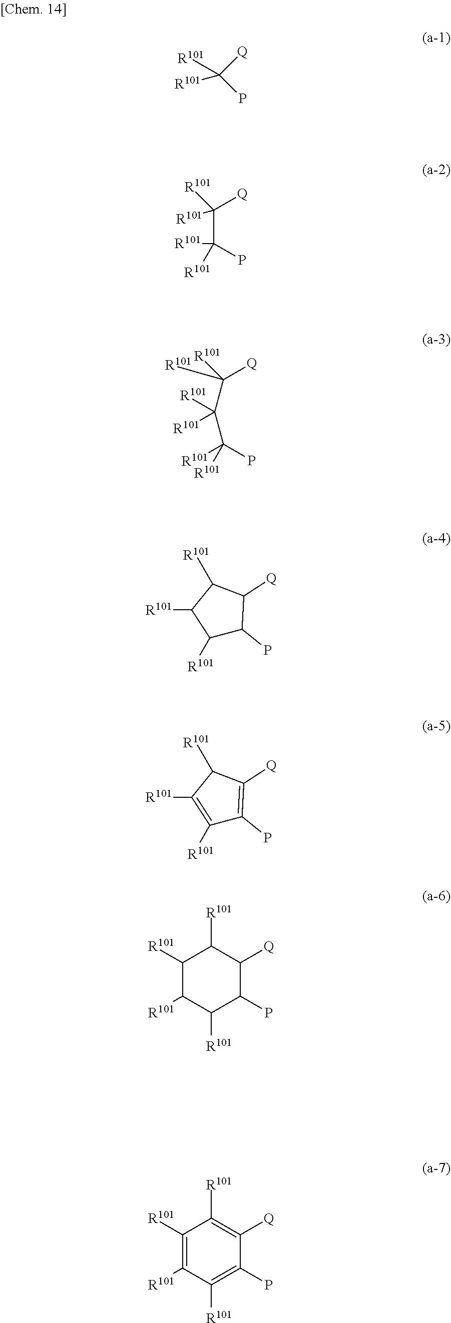

L represents a zero-valent ligand capable of leaving from metal.

L is preferably such a compound that contains an electron donating group and can be coordinated to the transition metal M to stabilize the metal complex. As L, a hydrocarbon compound containing 1 to 20 carbon atoms and containing oxygen, nitrogen or sulfur as an atom that can be coordinated to the transition metal, or a hydrocarbon compound containing a carbon-carbon unsaturated bond that can be coordinated to the transition metal (and optionally containing a heteroatom) may be used. The number of the carbon atoms of L is preferably from 1 to 16, and more preferably from 1 to 10.

As L, preferred examples include, but are not limited to, pyridines, piperidines, alkyl ethers, aryl ethers, alkyl aryl ethers, cyclic ethers, an alkyl nitrile derivative, an aryl nitrile derivative, alcohols, amides, aliphatic esters, aromatic esters, amines, and cyclic unsaturated hydrocarbons.

As L containing a sulfur atom, examples include, but are not limited to, dimethyl sulfoxide (DMSO). As L containing a nitrogen atom, examples include, but are not limited to, trialkylamine containing 1 to 10 carbon atoms in an alkyl group, dialkylamine containing 1 to 10 carbon atoms in an alkyl group, pyridine, 2,6-dimethylpyridine (also known as 2,6-lutidine), aniline, 2,6-dimethylaniline, 2,6-diisopropylaniline, N,N,N′,N′-tetramethylethylenediamine (TMEDA), 4-(N, N-dimethylamino)pyridine (DMAP), acetonitrile, benzonitrile, quinoline and 2-methylquinoline. As L containing an oxygen atom, examples include, but are not limited to, diethyl ether, tetrahydrofuran and 1,2-dimethoxyethane. From the viewpoint of the stability and catalytic activity of the complex, L is preferably dimethyl (DMSO), sulfoxide pyridine, 2,6-dimethylpyridine (also known as 2,6-lutidine) or N,N,N′,N′-tetramethylethylenediamine (TMEDA), and more preferably dimethyl sulfoxide (DMSO) or 2,6-dimethylpyridine (also known as 2,6-lutidine).

R²⁵ and L optionally form a ring. An example of this case is a cycloocta-1-enyl group, which is also a preferred embodiment in the present disclosure.

R²⁵ represents a hydrogen atom or a hydrocarbon group containing 1 to 30 carbon atoms and optionally containing a functional group. Each of R²⁶ and R²⁷ represents a hydrocarbon group containing 1 to 30 carbon atoms and optionally containing a functional group.

As the hydrocarbon group containing 1 to 30 carbon atoms in R²⁵, R²⁶ and R²⁷, examples include, but are not limited to, those exemplified above as the hydrocarbon group containing 1 to 30 carbon atoms in the general formulae (I) and (II).

The functional group in R²⁵, R²⁶ and R²⁷ may be the same as the functional group in A.

R²⁵ is preferably a hydrocarbon group containing 1 to 20 carbon atoms, a halogen-substituted hydrocarbon group containing 1 to 20 carbon atoms, or a hydrocarbon group containing 1 to 20 carbon atoms and being substituted with an alkoxy or aryloxy group. The number of the carbon atoms of the hydrocarbon group is preferably from 1 to 10. More specifically, R²⁵ is more preferably an alkyl group containing 1 to 3 carbon atoms, a benzyl group, a trifluoromethyl group, a pentafluorophenyl group, a 1-(methoxymethyl)ethyl group, a 1-(ethoxymethyl)ethyl group, a 1-(phenoxymethyl)ethyl group or a 1-(2,6-dimethylphenoxy methyl)ethyl group, and R²⁵ is still more preferably a methyl group or a benzyl group.

R²⁶ and R²⁷ are present in the vicinity of the transition metal M and sterically and/or electronically exert an interaction with the transition metal M. To exert such an effect, R²⁶ and R²⁷ are preferably bulky. The number of the carbon atoms of R²⁶ and R²⁷ is preferably from 3 to 30, and more preferably from 6 to 20.

Each of R²⁶ and R²⁷ is preferably an alkyl group containing 3 to 10 carbon atoms and optionally containing a functional group, a cycloalkyl group containing 6 to 20 carbon atoms and optionally containing a functional group, or an aryl group containing 6 to 20 carbon atoms and optionally containing a functional group.

The alkyl group containing 3 to 10 carbon atoms in R²⁶ and R²⁷ is preferably an n-propyl group, an isopropyl group, an n-butyl group, an isobutyl group, an s-butyl group or a t-butyl group.

As the cycloalkyl group containing 6 to 20 carbon atoms and optionally containing a functional group in R²⁶ and R²⁷, examples include, but are not limited to, a cyclohexyl group, a cycloheptyl group and a cyclooctyl group, all of which optionally contain a functional group and are optionally substituted with a linear or branched alkyl group containing 3 to 10 carbon atoms.

Also, the cycloalkyl group may be any of the cycloalkyl groups shown in paragraphs 0104 to 0113 in JP-A No. 2018-141138 (“X” shown in paragraphs 0104 to 0113 in JP-A No. 2018-141138 represents the linking position of P (a phosphorus atom) in the general formula (101) of the present disclosure).

From the viewpoint of polymer molecular weight control and polar monomer copolymerizability control, each of R²⁶ and R²⁷ is preferably a cyclohexyl group optionally being substituted with a linear or branched alkyl group containing 3 to 10 carbon atoms, and more preferably a cyclohexyl group being substituted with a linear or branched alkyl group containing 3 to 10 carbon atoms. Each of R²⁶ and R²⁷ may be a cyclohexyl group or a 2-isopropyl-5-methylcyclohexyl group (a menthyl group).

As the aryl group containing 6 to 20 carbon atoms and optionally containing a functional group in R²⁶ and R²⁷, examples include, but are not limited to, a phenyl group, a naphthyl group and an anthracenyl group. The aryl group optionally contains a functional group; moreover, it is optionally substituted with a linear or branched alkyl group containing 3 to 10 carbon atoms. The aryl group containing 6 to 20 carbon atoms is preferably substituted with a functional group containing at least one kind of an oxygen atom and a nitrogen atom. When the aryl group containing 6 to 20 carbon atoms is substituted with a functional group containing at least one of an oxygen atom and a nitrogen atom, the functional group is preferably substituted at the ortho position with respect to a carbon atom bound to a phosphorus atom. This is because, as a result, at least one kind of an oxygen atom and a nitrogen atom in R²⁶ and R²⁷ can be spatially arranged so as to interact with the transition metal M.

As R²⁶ and R²⁷, preferred examples include, but are not limited to, a 2-methoxyphenyl group, a 2,6-dimethoxyphenyl group, a 2,4,6-trimethoxyphenyl group, a 4-methyl-2,6-dimethoxyphenyl group, a 4-t-butyl-2,6-dimethoxyphenyl group, a 1,3-dimethoxy-2-naphthyl group, a 2,6-diethoxyphenyl group, a 2,4,6-triethoxyphenyl group, a 4-methyl-2,6-diethoxyphenyl group, a 4-t-butyl-2,6-diethoxyphenyl group, a 1,3-diethoxy-2-naphthyl group, a 2,6-diphenoxyphenyl group, a 2,4,6-triphenoxyphenyl group, a 4-methyl-2,6-diphenoxyphenyl group, a 4-t-butyl-2,6-diphenoxyphenyl group, a 1,3-diphenoxy-2-naphthyl group, a 2,6-dimethoxymethylphenyl group, a 2,4,6-trimethoxymethylphenyl group, a 4-methyl-2,6-dimethoxymethylphenyl group, a 4-t-butyl-2,6-dimethoxymethylphenyl group, a 1,3-dimethoxymethyl-2-naphthyl group, a 2,6-diphenoxymethylphenyl group, a 2,4,6-triphenoxymethylphenyl group, a 4-methyl-2,6-diphenoxymethylphenyl group, a 4-t-butyl-2,6-diphenoxymethylphenyl group, a 1,3-diphenoxymethyl-2-naphthyl group, a 2,6-di(2-methoxyethyl)phenyl group, a 2,4,6-tri (2-methoxyethyl)phenyl group, a 4-methyl-2,6-di(2-methoxyethyl)phenyl group, a 4-t-butyl-2,6-di(2-methoxyethyl)phenyl group, a 1,3-di(2-methoxyethyl)-2-naphthyl group, a 2,6-di(2-phenoxyethyl)phenyl group, a 2,4,6-tri (2-phenoxyethyl)phenyl group, a 4-methyl-2,6-di(2-phenoxyethyl)phenyl group, a 4-t-butyl-2,6-di(2-phenoxyethyl)phenyl group, and a 1,3-di(2-phenoxyethyl)-2-naphthyl group.

Each of R²⁶ and R²⁷ may be bound to A to form a ring structure. As the ring structure, examples include the structures described in paragraphs 0120 and 0121 in JP-A No. 2018-141138 (these examples indicate the case where the substituent R²⁶ and A are bound to form a ring structure); P and Q have the same meaning as those in the general formula (101) of the present disclosure; R¹⁷ has the same meaning as R²⁷ in the general formula (101) of the present disclosure and R¹⁰⁴ has the same meaning as R¹⁰¹ in the general formula (101) of the present disclosure.)

Among the compounds represented by the general formula (101) of the present disclosure, a compound represented by the following general formula (102) is preferred from the viewpoint of polymer production efficiency:

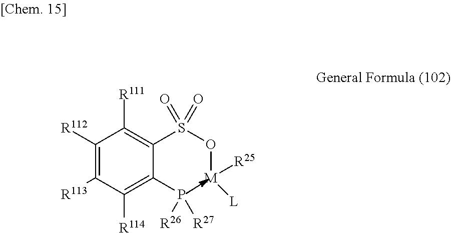

(where M, L, R²⁵, R²⁶ and R²⁷ have the same meaning as those in the general formula (101), and R¹¹¹, R¹¹², R¹¹³ and R¹¹⁴ each independently represents a hydrogen atom, a hydrocarbon group containing 1 to 30 carbon atoms, or a functional group.)

In the general formula (102), the hydrocarbon group containing 1 to 30 carbon atoms and the functional group in R¹¹¹, R¹¹², R¹¹³ and R¹¹⁴ may be the same as those of the above-described A.

All of R¹¹¹, R¹¹², R¹¹³ and R¹¹⁴ may be hydrogen atoms.

There is a tendency that bulky R¹¹¹ is likely to give a high-molecular-weight polymer. Accordingly, a substituent such as a t-butyl group, a trimethylsilyl group, a phenyl group, a 9-anthracenyl group, a 4-t-butylphenyl group, a 2,4-di-t-butylphenyl group and a pentafluorophenyl group may be appropriately selected as R¹¹¹.

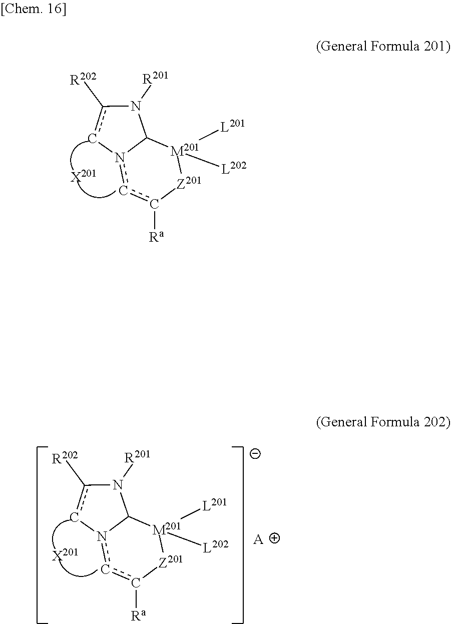

In the general formulae (201) and (202), M²⁰¹ represents a transition metal of the Groups 8 to 10 of the periodic table. As M²⁰¹, examples include, but are not limited to, Fe, Co, Ni, Pd and Pt.

L²⁰¹ and L²⁰² each represents a ligand coordinated to M²⁰¹, and L²⁰¹ and L²⁰² each independently represents a halogen atom, a hydrogen atom, or a hydrocarbon group containing 1 to 20 carbon atoms and containing a heteroatom. L²⁰¹ and L²⁰² is optionally bound to each other to form a ring. As L²⁰¹ and L²⁰², examples include, but are not limited to, a halogen atom, a methyl group, a phenyl group, a benzyl group, pyridine and 2,6-lutidine.

Z²⁰¹ represents an oxygen atom, a sulfur atom, OR²⁰³, SR²⁰³, SO₃, SO₃R²⁰³, N═CR²⁰³R²⁰⁴, CR²⁰³═NR²⁰⁴, N(R²⁰³), N(R²⁰³)₂, P(R²⁰³), P(R²⁰³)₂, CO₂, CO₂R²⁰³, C(O)N(R²⁰³)₂, CO, C(O)R²⁰³, SO₂R²⁰³, SOR²⁰³, OSO₂R²⁰³, P(O)(OR²⁰³)_{2-y}(R²⁰⁴)_{y}, or P(R²⁰³)₂(O) (where R²⁰³ and R²⁰⁴ each independently represents a hydrogen atom or a hydrocarbon group containing 1 to 20 carbon atoms, and y represents an integer of from 0 to 2).

R²⁰¹ and R²⁰² each independently represents a hydrogen atom, or a hydrocarbon group containing 1 to 40 carbon atoms and optionally containing a heteroatom. As the hydrocarbon group containing 1 to 40 carbon atoms and optionally containing a heteroatom, examples include, but are not limited to, C(O)CH₃, C(O)CH₂CH₃, CH₂OCH₃, CH₂OCH₂CH₃, CH₂NH₂ and CH₂CH₂NH₂. The hydrocarbon group is preferably a hydrocarbon group containing 1 to 33 carbon atoms, such as an alkyl group, a cycloalkyl group, an aryl group and any combination thereof. As the hydrocarbon group containing 1 to 40 carbon atoms and optionally containing a heteroatom, preferred examples include, but are not limited to, a 1-propyl group, a 1-butyl group, a 1-pentyl group, a 1-hexyl group, 1-heptyl group, a 1-octyl group, a 1-nonyl group, a 1-decyl group, a t-butyl group, a tricyclohexylmethyl group, a 1,1-dimethyl-2-phenylethyl group, an isopropyl group, a 1-dimethylpropyl group, a 2,4,6-trimethylphenyl group, a 2,6-diisopropylphenyl group and a 2,6-dibenzhydryl-4-methylphenyl group.

X²⁰¹ represents a saturated or unsaturated, divalent hydrocarbon group containing 3 to 9 carbon atoms. A substituent may be present on the ring formed by the X²⁰¹.

R^{a} is a hydrogen atom, or a hydrocarbon group containing 1 to 10 carbon atoms and optionally containing a heteroatom, such as CH₃, CH₂CH₃, C(O)CH₃, C(O)CH₂CH₃, CH₂OCH₃, CH₂OCH₂CH₃, CH₂NH₂ and CH₂CH₂NH₂. R^{a} may be condensed with a part of the ring composed of X²⁰¹ to form a ring.

A⁺ represents a counter cation. As A⁺, examples include, but are not limited to, any cation such as K⁺ and Na⁺. Depending on the valence of M²⁰¹ and the type of Z²⁰¹, L²⁰¹ and L²⁰², the entire complex may be negatively charged. In this case, the counter cation A⁺ is needed. The valence of M²⁰¹ means the formal oxidation number used in organometallic chemistry.

Reference can be made to JP-A 2016-135777 or J. Am. Chem. Soc. 2015, 137, 10934, for detailed examples of the compound represented by the general formula (201) or (202).

The transition metal complex used in the present disclosure can be prepared by a conventionally known method. The compound represented by the general formula (101) can be produced by reference to JP-A No. 2018-141138, for example. The compound represented by the general formula (201) or (202) can be produced by reference to JP-A No. 2016-135777, for example.

In the present disclosure, a main catalytic component of the catalyst containing the transition metal is the transition metal complex described above. As needed, an activator, a support or the like may be used in combination. As the activator, examples include, but are not limited to, alkylalumoxane and a boron-containing compound, both of which are co-catalysts used in metallocene catalysts.

As the support, any support can be used without departing from the scope of the present invention. In general, an inorganic oxide or a polymer support can be preferably used as the support.

More specifically, as the support, examples include, but are not limited to, SiO₂, Al₂O₃, MgO, ZrO₂, TiO₂, B₂O₃, CaO, ZnO, BaO, ThO₂, and mixtures thereof. Also, a mixed oxide such as SiO₂—Al₂O₃, SiO₂—V₂O₅, SiO₂—TiO₂, SiO₂—MgO, SiO₂—Cr₂O₃ can be used. Also, inorganic silicate, a polyethylene support, a polypropylene support, a polystyrene support, a polyacrylic acid support, a polymethacrylic acid support, a polyacrylic acid ester support, a polyester support, a polyamide support, a polyimide support or the like may be used. The particle diameter, particle size distribution, pore volume, specific surface area and so on of these supports are not particularly limited, and any support can be used.

### (2) Monomer

In the production method of the present disclosure, at least the following monomer (A) for deriving the structural unit (A) and the following monomer (B) for deriving the structural unit (B) may be polymerized.

Monomer (A): At least one kind selected from the group consisting of ethylene and an olefin containing 3 to 20 carbon atoms

Monomer (B): At least one kind selected from the group consisting of a lactone monomer represented by the general formula (1) and a lactone monomer represented by the general formula (2)

As the at least one kind of monomer (A) selected from the group consisting of ethylene and an olefin containing 3 to 20 carbon atoms, the same monomer as the monomer (A) described above under “(1) Structural unit (A)” can be used.

For the at least one kind of monomer (B) selected from the group consisting of a lactone monomer represented by the general formula (1) and a lactone monomer represented by the general formula (2), R¹ to R⁹ and n in the general formula (1) may be the same as R¹ to R⁹, and n described above under “(2) Structural unit (B). R¹¹ to R¹⁹ and n in the general formula (2) may be the same as R¹¹ to R¹⁹ and n described above under “(2) Structural unit (B)”.

As the monomer (B), examples include, but are not limited to, the following structural units:

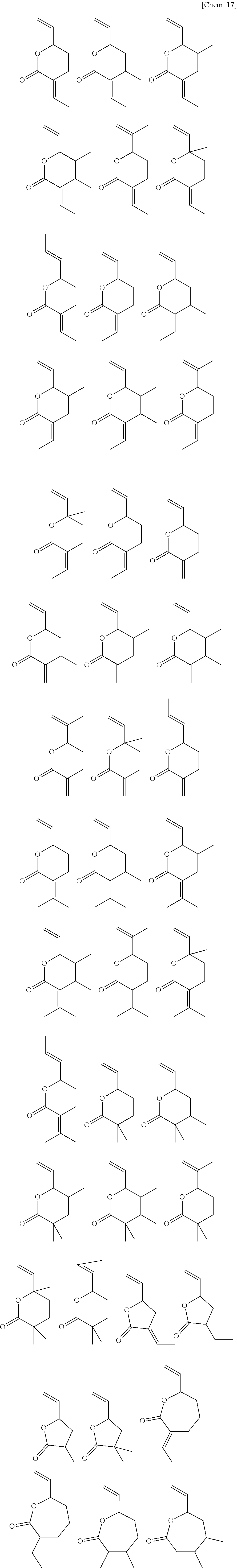

The monomer (B) can be synthesized by a technique known in the art, or a commercially-available product can be used as the monomer (B).

For example, the lactone monomer represented by the general formula (1) can be synthesized by use of carbon dioxide and a diene such as butadiene. As the diene, examples include, but are not limited to, 1,3-butadiene, 1,3-pentadiene, isoprene and 1,2-butadiene. The lactone monomer represented by the general formula (1) can be synthesized by reference to J. Organomet. Chem. 1983, 255, 263-268 or U.K. Patent Application Publication No. 2550876, for example. The substituent of the lactone monomer represented by the general formula (1) can be introduced into a 1,3-diene by a known method.

The lactone monomer represented by the general formula (2) can be synthesized by reference to, for example, intramolecular cyclization reaction of unsaturated carboxylic acid described in the following, for example: SYNLETT, 2015, 26, 2237-2242; Chem. Sci. 2012, 3, 789-793; and J. Org. Chem. 1993, 58, 5298-5300. The substituent of the lactone monomer represented by the general formula (2) may be introduced by a known method in the synthesis of unsaturated carboxylic acid, or the substituent may be introduced into the lactone monomer by a known method.

The substituent of the structural unit (B) may be introduced after the polymerization of the lactone monomer.

As the monomer (C) that derives another structural unit (C), a monomer that can be copolymerized with the monomer (A) in the presence of the transition metal catalyst of the Groups 4 to 10 of the periodic table, can be used. As the monomer (C), the same monomer as the monomer (C) described above under “(3) Another structural unit (C)” can be used.

### (3) Polymerization Method

In the method for producing the polar group-containing olefin copolymer according to the present disclosure, the polymerization method is not particularly limited.

For example, solution polymerization in which all of the produced polymer is dissolved in a medium, slurry polymerization in which at least a part of the produced polymer is made into slurry in a medium, or bulk polymerization in which a liquefied monomer itself is used as a medium, may be used.

The polymerization form may be any of batch polymerization, semibatch polymerization and continuous polymerization.

Reference can be made to, for example, JP-A No. 2010-260913 or 2010-202647 for the details of the production process and condition.

Unreacted monomers and a medium may be separated from a produced polymer and recycled for use. When recycling the unreacted monomers and the medium, they may be refined and reused, or they may be reused without refinement. To separate the unreacted monomers and the medium from the produced polymer, a conventionally known method can be used. For example, a method such as filtration, centrifugal separation, solvent extraction, and reprecipitation with a poor solvent can be used.

The polymerization temperature, the polymerization pressure and the polymerization time are not particularly limited. In general, they may be optimally set in any of the following ranges, considering productivity and processing capability.

That is, the polymerization temperature is generally from −20° C. to 290° C., preferably from 0° C. to 250° C., more preferably from 0° C. to 200° C., still more preferably from 10° C. to 150° C., particularly preferably from 20° C. to 100° C. The polymerization pressure is from 0.1 MPa to 100 MPa, preferably from 0.3 MPa to 90 MPa, more preferably from 0.5 MPa to 80 MPa, still more preferably from 1.0 MPa to 70 MPa, and particularly preferably from 1.3 MPa to 60 MPa. The polymerization times can be selected from 0.1 minutes to 50 hours, preferably from 0.5 minutes to 40 hours, and still more preferably from 1 minute to 30 hours.

In the present disclosure, the polymerization is generally carried out in an inert atmosphere. For example, a nitrogen or argon atmosphere can be used, and a nitrogen atmosphere is preferably used.

The supply of the catalyst and the monomers to a polymerization reactor is not particularly limited. The method for supplying them may be selected from various kinds of supplying methods, depending on the purpose. For example, in the case of batch polymerization, the following method can be employed: predetermined amounts of monomers are supplied to the polymerization reactor in advance, and then the catalyst is supplied thereto. In this case, an additional monomer or an additional catalyst may be supplied to the polymerization reactor. In the case of continuous polymerization, the following method can be employed: predetermined amounts of monomers and catalyst are continuously or intermittently supplied to the polymerization reactor for continuous polymerization reaction.

The composition of the copolymer can be controlled by any of the following methods, for example:
1) To change the ratio of the supplied monomers
2) To use a difference in monomer reactivity ratio due to a difference in catalyst structure
3) To use the polymerization temperature dependency of the monomer reactivity ratio

The molecular weight of the copolymer can be controlled by a conventionally known method. As the method, examples include, but are not limited to, the following method.
1) To control the polymerization temperature
2) To control the monomer concentration
3) To control the ligand structure in the transition metal complex
4) To use a known chain transfer agent such as hydrogen

### EXAMPLES

The present disclosure will be described in more detail, with reference to the following examples. The present disclosure is not limited to these examples, as long as it does not depart from the gist of the present disclosure. The physical properties of the polar group-containing olefin copolymer and so on were measured by the following method.

### [Structure of the Polar Group-Containing Olefin Copolymer]

The structure of the polar group-containing olefin copolymer was determined by ¹H-NMR and ¹³C-NMR analysis with ASCEND 500 manufactured by Bruker Corporation or AVANCE 400 manufactured by Bruker Corporation.

In the NMR measurement, 1,1,2,2-tetrachloroethane-d2 was used as a solvent. In the ¹H-NMR measurement, the polymer concentration was set to 5 mass %. In the ¹³C-NMR measurement, the polymer concentration was set to 15 mass % The NMR measurement was carried out at 120° C. Meanwhile, a part of the NMR measurement was carried out at 120° C. using a homogeneous solution obtained by heating and dissolving about 150 mg of the polar group-containing olefin copolymer in 2.4 mL of a mixed solvent of 1,2-dichlorobenzene and bromobenzene-d5 in a ratio of 1:2.

The ¹H-NMR measurement was carried out in the following condition for quantitative analysis.

Pulse: 30° pulse of 50 microseconds

Spectral width: 10 kHz

Relaxation time: 5 seconds

Acquisition time: 3.2 seconds

FID accumulation times: 128 times

The ¹³C-NMR measurement was carried out in the following condition for quantitative analysis, by the inverse gated decoupling method using chromium (III) acetylacetonate as a relaxation reagent.

Pulse: 90° Pulse of 9.0 microseconds or 90° pulse of 15.8 microseconds

Spectral width: 31 kHz or 25 kHz

Relaxation time: 10 seconds or 50 seconds

Acquisition time: 10 seconds or 1.5 seconds

FID accumulation times: 5,000 to 10,000 times or 1,024 times

### [Content of the Structural Unit (B) in the Polar Group-Containing Olefin Copolymer]

The content of the structural unit (B) was measured as follows by ¹H-NMR.

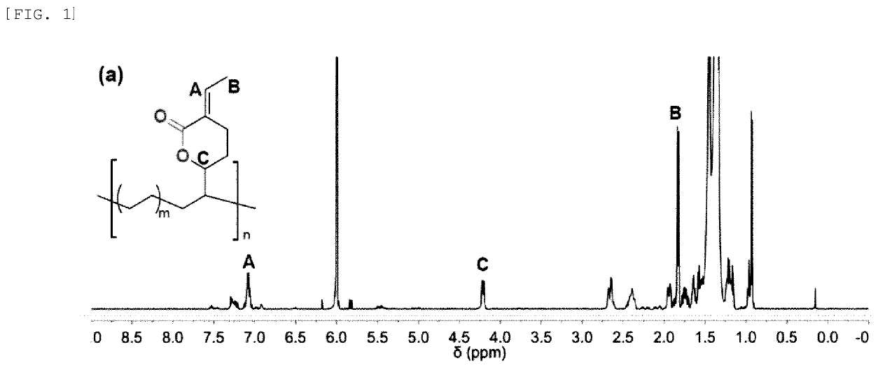

As an ethylene copolymer example, the 1H-NMR of the copolymer 8 of Example 8 is shown in FIG. 1.

In FIG. 1, an isolated peak inherent in a chemical shift of from 4.2 ppm to 4.3 ppm (position C) corresponds to 1H (one hydrogen atom) derived from the structural unit (B), and the peak area was defined as IB. The total of all peak areas except the solvent was defined as IA. The ratio of the structural unit (B) in all monomer units was obtained by the following formula: IB×4/(IA−IB×8).

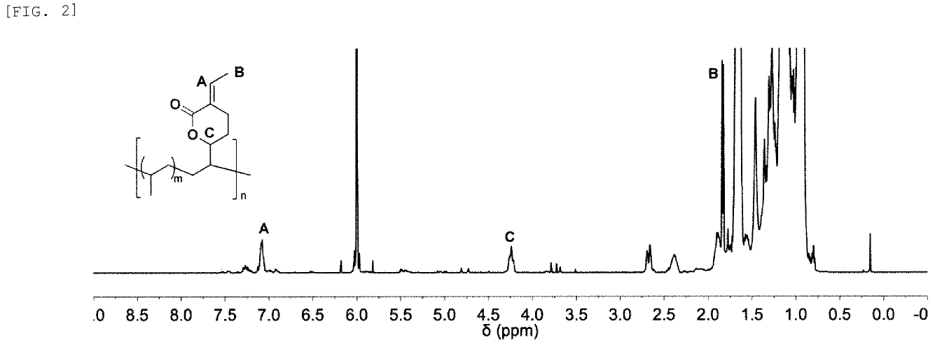

As a propylene copolymer example, the ¹H-NMR of the copolymer 11 of Example 11 is shown in FIG. 2.

In FIG. 2, an isolated peak inherent in a chemical shift of from 4.2 ppm to 4.3 ppm (position C) corresponds to 1H derived from the structural unit (B), and the peak area was defined as IB. The total of all peak areas except the solvent was defined as IA. The ratio of the structural unit (B) in all monomer units was obtained by the following formula: IB×6/(IA−IB×6).

### [Content of Another Structural Unit in the Polar Group-Containing Olefin Copolymer]

When a structural unit derived from methyl acrylate was contained as another structural unit (C), the content of the structural unit was measured as follows with ¹³C-NMR using the inverse gated decoupling method.

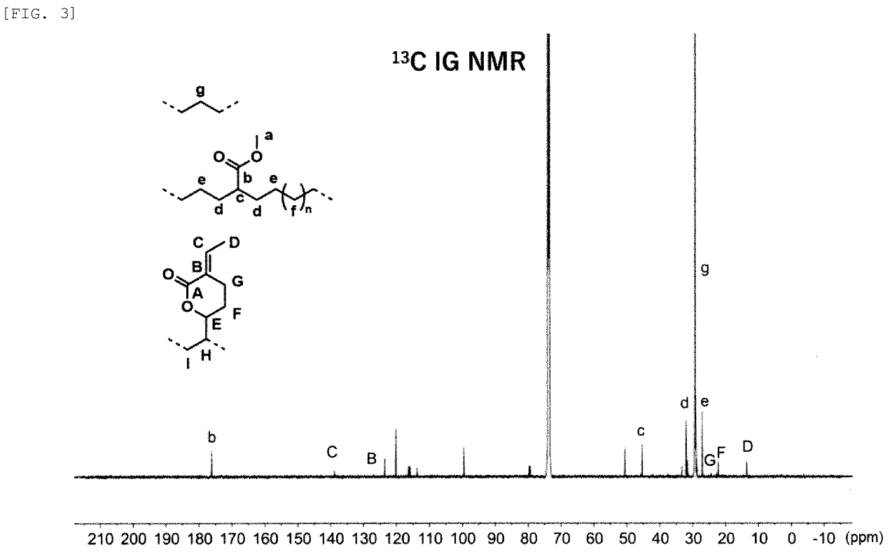

As an ethylene copolymer example, the ¹³C-NMR of the copolymer 12 of Example 12 is shown in FIG. 3.

In FIG. 3, an isolated peak inherent in a chemical shift of from 13 ppm to 14 ppm (position D) corresponds to 1 C (one carbon atom) derived from the structural unit (B). An isolated peak inherent in a chemical shift of from 22 ppm to 23 ppm (position F) corresponds to 1 C derived from the structural unit (B). An isolated peak inherent in a chemical shift of from 24 ppm to 25 ppm (position G) corresponds to 1 C derived from the structural unit (B). An isolated peak inherent in a chemical shift of from 126 ppm to 128 ppm (position B) corresponds to 1 C derived from the structural unit (B). An isolated peak inherent in a chemical shift of from 138 ppm to 140 ppm (position C) corresponds to 1 C derived from the structural unit (B). The average value of the five peak areas was defined as IB. In FIG. 3, an isolated peak inherent in a chemical shift of from 176 ppm to 177 ppm (position b) corresponds to 1 C derived from another structural unit (methyl acrylate), and the peak area was defined as IC. The total of all peak areas except the solvent was defined as IA. The ratio of the structural unit (B) in all monomer units was obtained by the following formula: (100×IB)/(((IA−IB×9−IC×4)/2)+IB+IC). The ratio of the structural unit (methyl acrylate) in all monomer units was obtained by the following formula: (100×IC)/(((IA−IB×9−IC×4)/2)+IB+IC).

### [Number Average Molecular Weight and Weight Average Molecular Weight]

A number average molecular weight (Mn) and a weight average molecular weight (Mw) were calculated by size exclusion chromatography in which polystyrene was used as a standard substance for molecular weight, in the following condition.

Device: High temperature GPC device HLC-8321GPC/HT manufactured by Tosoh Corporation

Columns: TSKgel GMHHR-H(S)HT columns manufactured by Tosoh Corporation (two 7.8 mm I.D.×30 cm columns in series)

Solvent: 1,2-Dichlorobenzene

Temperature: 145° C.

or

Device: High temperature GPC device ALC/GPC 150C manufactured by Waters Corporation

Columns: AT-806 MS columns manufactured by Showa Denko K. K. (three 8.0 mm I.D.×25 cm columns in series)

Solvent: 1,2-dichlorobenzene

Temperature: 140° C.

### [Synthesis of Transition Metal Complex]

### Synthesis Example 1

A transition metal complex (A) represented by the following chemical formula (A) where both Rs represent menthyl (2-isopropyl-5-methylcyclohexyl) and Lut represents 2,6-dimethylpyridine, was synthesized as described in JP-A No. 2017-031300. In the present DESCRIPTION, Me represents methyl.

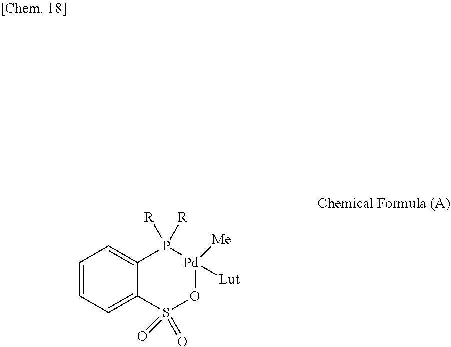

### Synthesis Example 2

A transition metal complex (B) represented by the chemical formula (A) where both Rs represent cyclohexyl and Lut represents 2,6-dimethylpyridine, was synthesized as described in JP-A No. 2011-068881.

### Synthesis Example 3

A transition metal complex (C) represented by the chemical formula (A) where both Rs represent isopropyl and Lut represents 2,6-dimethylpyridine, was synthesized as described in JP-A No. 2013-079347.

### Synthesis Example 4

A transition metal complex (D) represented by the chemical formula (A) where both Rs represent 2-methoxyphenyl and Lut represents 2,6-dimethylpyridine, was synthesized as described in JP-A No. 2007-046032.

### Synthesis Example 5

A transition metal complex (E) represented by the following chemical formula (B) where R represents 2,4,6-trimethylphenyl and Lut represents 2,6-dimethylpyridine, was synthesized as described in J. Am. Chem. Soc. 2015, 137, 10934.

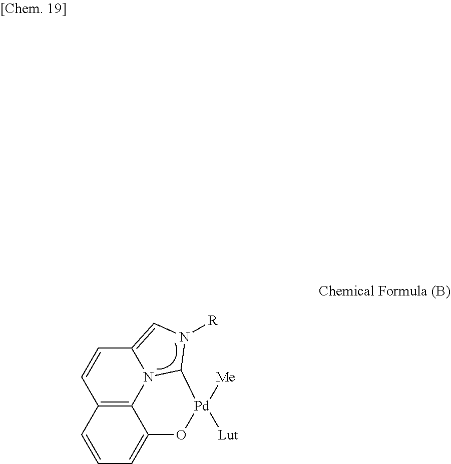

### Synthesis Example 6

A transition metal complex (F) represented by the chemical formula (B) where R represents 2,6-diisopropylphenyl and Lut represents 2,6-dimethylpyridine, was synthesized as described in J. Am. Chem. Soc. 2015, 137, 10934.

### Example 1

In a nitrogen atmosphere, the transition metal complex (A)(6.9 mg, 0.010 mmol) as the catalyst, toluene (10 mL) as the solvent, and 6-ethenyl-3-ethylidene tetrahydro-2H-pyran-2-one (1.0 mL, 6.6 mmol) as the monomer (B) were successively put in a 50 mL autoclave. While the autoclave was pressurized with ethylene (the monomer (A))(3.0 MPa), the mixture was stirred for 3 hours at a reaction temperature of 80° C. The temperature of the autoclave was returned to room temperature, and methanol (20 mL) was added thereto. A precipitated solid was collected by filtration, washed with methanol, and then dried under reduced pressure. A polar group-containing olefin copolymer 1 thus obtained was 509 mg. The analysis results of the polar group-containing olefin copolymer 1 are shown in Table 1.

### Example 2

Preparation of a polar group-containing olefin copolymer 2 was carried out in the same manner as Example 1, except that the catalyst was changed to the transition metal complex (B) (5.8 mg, 0.010 mmol). The thus-obtained polar group-containing olefin copolymer 2 was 1479 mg. The analysis results of the polar group-containing olefin copolymer 2 are shown in Table 1.

### Example 3

Preparation of a polar group-containing olefin copolymer 3 was carried out in the same manner as Example 1, except that the catalyst was changed to the transition metal complex (C) (5.0 mg, 0.010 mmol). The thus-obtained polar group-containing olefin copolymer 3 was 549 mg. The analysis results of the polar group-containing olefin copolymer 3 are shown in Table 1.

### Example 4

Preparation of a polar group-containing olefin copolymer 4 was carried out in the same manner as Example 1, except that the catalyst was changed to the transition metal complex (D) (6.3 mg, 0.010 mmol). The thus-obtained polar group-containing olefin copolymer 4 was 382 mg. The analysis results of the polar group-containing olefin copolymer 4 are shown in Table 1.

### Example 5

Preparation of a polar group-containing olefin copolymer 5 was carried out in the same manner as Example 1, except that the catalyst was changed to the transition metal complex (E) (5.7 mg, 0.010 mmol). The thus-obtained polar group-containing olefin copolymer 5 was 17 mg.

The analysis results of the polar group-containing olefin copolymer 5 are shown in Table 1.

### Example 6

Preparation of a polar group-containing olefin copolymer 6 was carried out in the same manner as Example 1, except that the catalyst was changed to the transition metal complex (F) (5.3 mg, 0.010 mmol). The thus-obtained polar group-containing olefin copolymer 6 was 73 mg. The analysis results of the polar group-containing olefin copolymer 6 are shown in Table 1.

### Example 7

Preparation of a polar group-containing olefin copolymer 7 was carried out in the same manner as Example 6, except that the reaction temperature was changed to 60° C. The thus-obtained polar group-containing olefin copolymer 7 was 61 mg. The analysis results of the polar group-containing olefin copolymer 7 are shown in Table 1.

### Example 8

Preparation of a polar group-containing olefin copolymer 8 was carried out in the same manner as Example 6, except that the reaction temperature was changed to 100° C. The thus-obtained polar group-containing olefin copolymer 8 was 61 mg. The analysis results of the polar group-containing olefin copolymer 8 are shown in Table 1.

### Example 9

Preparation of a polar group-containing olefin copolymer 9 was carried out in the same manner as Example 6, except that 6-ethenyl-3-ethylidene tetrahydro-2H-pyran-2-one as the monomer (B) was changed to 0.5 mL, 3.3 mmol. The thus-obtained polar group-containing olefin copolymer 9 was 150 mg. The analysis results of the polar group-containing olefin copolymer 9 are shown in Table 1.

### Example 10

Preparation of a polar group-containing olefin copolymer 10 was carried out in the same manner as Example 6, except that 6-ethenyl-3-ethylidene tetrahydro-2H-pyran-2-one as the monomer (B) was changed to 0.2 mL, 1.3 mmol. The thus-obtained polar group-containing olefin copolymer 10 was 284 mg. The analysis results of the polar group-containing olefin copolymer 10 are shown in Table 1.

### Example 11

In a nitrogen atmosphere, the transition metal complex (E)(5.7 mg, 0.010 mmol) as the catalyst, toluene (10 mL) as the solvent, and 6-ethenyl-3-ethylidene tetrahydro-2H-pyran-2-one (0.1 mL, 0.66 mmol) as the monomer (B) were successively put in a 50 mL autoclave. After the autoclave was cooled down to 0° C., pressurized with propylene (the monomer (A))(10 g) and then hermetically closed, the mixture was stirred for 12 hours at a reaction temperature of 80° C. The temperature of the autoclave was returned to room temperature, and methanol (20 mL) was added thereto. A precipitated solid was collected by filtration, washed with methanol, and then dried under reduced pressure. A polar group-containing olefin copolymer 11 thus obtained was 50 mg. For the polar group-containing olefin copolymer 11, the number average molecular weight was 2700; the molecular weight distribution Mw/Mn was 2.1; and the content of the structural unit (B) was 1.9 mol %.

### Example 12

In a nitrogen atmosphere, the transition metal complex (C)(5.0 mg, 0.010 mmol) as the catalyst, toluene (10 mL) as the solvent, 6-ethenyl-3-ethylidene tetrahydro-2H-pyran-2-one (1.0 mL, 6.6 mmol) as the monomer (B), and methyl acrylate (1.0 mL, 11 mmol) as the monomer (C) serving as another structural unit were successively put in a 50 mL autoclave. While the autoclave was pressurized with ethylene (the monomer (A))(3.0 MPa), the mixture was stirred for 3 hours at a reaction temperature of 80° C. The temperature of the autoclave was returned to room temperature, and methanol (20 mL) was added thereto. A precipitated solid was collected by filtration, washed with methanol, and then dried under reduced pressure. A polar group-containing olefin copolymer 12 thus obtained was 876 mg. For the polar group-containing olefin copolymer 12, the number average molecular weight was 126600; the molecular weight distribution Mw/Mn was 1.0; the content of the structural unit (B) was 0.14 mol %; and the content of the structural unit derived from methyl acrylate (another structural unit (C)) was 0.78 mol %. The degree of methyl branching was 0.22 per 1000 carbon atoms.

TABLE 1

| | | | | | | | | Degree of methyl |
|---|---|---|---|---|---|---|---|---|
| | | | | Catalytic | | | Structural | branching |
| | | | Yield | activity | Mn | | unit (B) | (Number/1000 |
| Example | Catalyst | Copolymer | (mg) | (kg/mol/h) | (kg/mol) | Mw/Mn | (mol %) | carbon atoms) |
| Example 1 | A | Copolymer 1 | 509 | 17.0 | 25.3 | 2.9 | 0.02 | 0.70 |
| Example 2 | B | Copolymer 2 | 1479 | 48.0 | 8.7 | 2.5 | 0.15 | 0.63 |
| Example 3 | C | Copolymer 3 | 549 | 18.0 | 6.5 | 2.7 | 0.17 | Not observed |
| Example 4 | D | Copolymer 4 | 382 | 13.0 | 6.4 | 3.1 | 0.20 | 0.72 |
| Example 5 | E | Copolymer 5 | 17 | 0.6 | 0.7 | 4.7 | 3.70 | 13.8 |
| Example 6 | F | Copolymer 6 | 73 | 2.4 | 6.0 | 2.9 | 2.10 | 13.8 |
| Example 7 | F | Copolymer 7 | 61 | 2.0 | 6.1 | 2.2 | 2.20 | 6.50 |
| Example 8 | F | Copolymer 8 | 61 | 2.0 | 6.5 | 2.2 | 2.30 | 19.6 |
| Example 9 | F | Copolymer 9 | 150 | 5.0 | 15 | 1.9 | 1.10 | 14.4 |
| Example 10 | F | Copolymer 10 | 284 | 9.5 | 32 | 1.7 | 0.47 | 14.4 |

A structural unit derived from a lactone monomer, which is different from the structural unit (B), was not contained in the polar group-containing olefin copolymers of Examples 1 to 12.

### INDUSTRIAL APPLICABILITY

The novel polar group-containing olefin copolymer of the present disclosure is a novel polar group-containing olefin copolymer in which a lactone structure is introduced into a side chain of a polymer chain, and it is applicable in various ways to highly functionalize olefin-based polymers.

The polar group-containing olefin copolymer of the present disclosure can easily produce a polar group-containing olefin copolymer containing acid or alcohol by, for example, hydrolyzing the lactone structure introduced in the side chain, and the carboxy or hydroxy group can be used.

When the polar group-containing olefin copolymer of the present disclosure contains the structural unit represented by the general formula t contains an ethylenically unsaturated group in the side chain and can be post-modified, accordingly. For example, the polar group-containing olefin copolymer of the present disclosure can be crosslinked, and it also shows promise as a macromonomer.

For example, when the polar group-containing olefin copolymer of the present disclosure contains the structural unit represented by the general formula (I), it contains an enone structure in the side chain. Accordingly, the polar group-containing olefin copolymer of the present disclosure can be used as a substrate for Michael addition reaction, for example.

As described above, the polar group-containing olefin copolymer of the present disclosure is expected to be a raw material that can be turned into various kinds of composite materials.

The polar group-containing olefin copolymer of the present disclosure also possesses an additional value as a carbon recycled resin, since the 6-membered lactone monomer containing the ethylenically unsaturated group that derives the structural unit (B), can be also derived from carbon dioxide.

1. A polar group-containing olefin copolymer comprising:
a structural unit (A) derived from at least one kind of monomer selected from the group consisting of ethylene and an olefin containing 3 to 20 carbon atoms, and
at least one kind of structural unit (B) selected from the group consisting of a structural unit represented by the following general formula (I) and a structural unit selected from the following general formula (II): 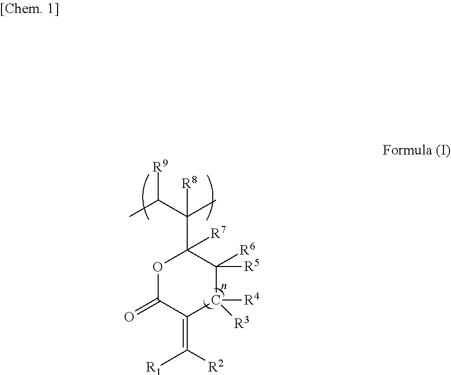
(where R¹, R², R³, R⁴, R⁵ and R⁶ each independently represents a hydrogen atom or a hydrocarbon group containing 1 to 30 carbon atoms and optionally containing a substituent;
R⁷, R⁸ and R⁹ each independently represents a hydrogen atom or a hydrocarbon group containing 1 to 3 carbon atoms; and
n is 0, 1 or 2, and when n=0, adjacent carbon atoms are directly bound to each other, and R³ and R⁴ are absent) 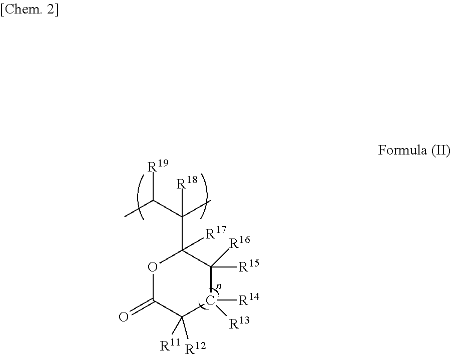
(where R¹¹, R¹², R¹³, R¹⁴, R¹⁵ and R¹⁶ each independently represents a hydrogen atom or a hydrocarbon group containing 1 to 30 carbon atoms and optionally containing a substituent;
R¹⁷, R¹⁸ and R¹⁹ each independently represents a hydrogen atom or a hydrocarbon group containing 1 to 3 carbon atoms; and
n is 0, 1 or 2, and when n=0, adjacent carbon atoms are directly bound to each other, and R¹³ and R¹⁴ are absent).

2. The polar group-containing olefin copolymer according to claim 1, wherein a ratio (Mw/Mn) of a weight average molecular weight (Mw) to a number average molecular weight (Mn), both of which are obtained by gel permeation chromatography (GPC), is in a range of from 1.5 to 5.0.

3. The polar group-containing olefin copolymer according to claim 1, wherein the structural unit (A) is derived from ethylene, and a degree of methyl branching calculated by ¹³C-NMR is 20.0 or less per 1,000 carbon atoms.

4. A method for producing the polar group-containing olefin copolymer defined by claim 1, wherein the polar group-containing olefin copolymer is produced in the presence of a transition metal catalyst of the Groups 4 to 10 of the periodic table.

5. The method for producing the polar group-containing olefin copolymer according to claim 4, wherein the transition metal catalyst is a transition metal catalyst in which a chelating phosphine compound or a chelating carbene compound is coordinated to nickel or palladium metal.

6. A method for producing a polar group-containing olefin copolymer,
wherein the following monomer (A) and the following monomer (B) are polymerized in the presence of a catalyst containing a transition metal of the Groups 4 to 10 of the periodic table:
monomer (A): at least one kind selected from the group consisting of ethylene and an olefin containing 3 to 20 carbon atoms
monomer (B): at least one kind selected from the group consisting of a lactone monomer represented by the following general formula (1) and a lactone monomer represented by the following general formula (2): 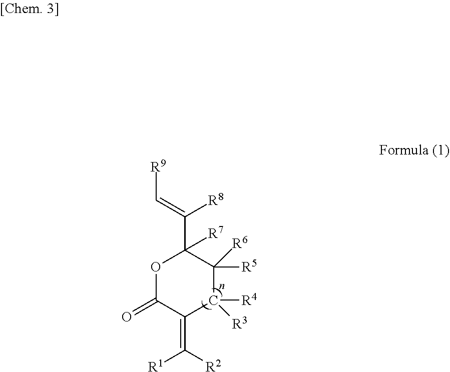
(where R¹, R², R³, R⁴, R⁵ and R⁶ each independently represents a hydrogen atom or a hydrocarbon group containing 1 to 30 carbon atoms and optionally containing a substituent;
R⁷, R⁸ and R⁹ each independently represents a hydrogen atom or a hydrocarbon group containing 1 to 3 carbon atoms; and
n is 0, 1 or 2, and when n=0, adjacent carbon atoms are directly bound to each other, and R³ and R⁴ are absent) 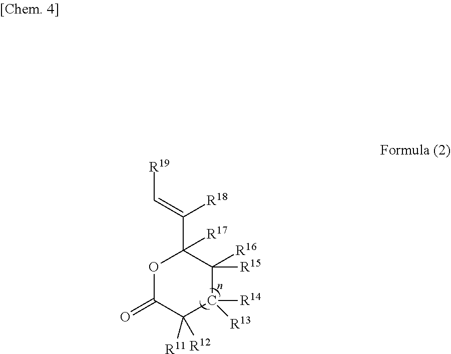
(where R¹¹, R¹², R¹³, R¹⁴, R¹⁵ and R¹⁶ each independently represents a hydrogen atom or a hydrocarbon group containing 1 to 30 carbon atoms and optionally containing a substituent;
R¹⁷, R¹⁸ and R¹⁹ each independently represents a hydrogen atom or a hydrocarbon group containing 1 to 3 carbon atoms; and
n is 0, 1 or 2, and when n=0, adjacent carbon atoms are directly bound to each other, and R¹³ and R¹⁴ are absent).
